(19) United States
(12) Patent Application Publication
(10) Pub. No.: US 2022/0210810 A1
(43) Pub. Date: Jun. 30, 2022

(54) RESOURCE SIGNALING TECHNIQUES FOR MULTIPLE REPETITIONS OF UPLINK TRANSMISSIONS

(71) Applicant: QUALCOMM Incorporated, San Diego, CA (US)

(72) Inventors: Mostafa Khoshnevisan, San Diego, CA (US); Yitao Chen, San Diego, CA (US); Jing Sun, San Diego, CA (US); Xiaoxia Zhang, San Diego, CA (US)

(21) Appl. No.: 17/538,562

(22) Filed: Nov. 30, 2021

Related U.S. Application Data
(60) Provisional application No. 63/131,161, filed on Dec. 28, 2020.

(51) Int. Cl. H04W 72/12; H04L 5/00

(52) U.S. Cl. CPC H04W 72/1278; H04W 72/1268; H04L 5/0048

(57) ABSTRACT

Methods, systems, and devices for wireless communication are described in which a user equipment (UE) may transmit one or more uplink communications to multiple transmission-reception points (TRPs), which may include multiple repetitions to each of the multiple TRPs. Transmission parameters for each repetition may be based on parameters such as a number of antenna ports, a spatial domain filter or beam, a rank or number of layers, or any combinations thereof, that are determined from an indicated sounding reference signal (SRS) resource. The SRS resource may be selected from a set of SRS resources that are configured at the UE and indicated in control information that schedules the uplink communication. Multiple sets of SRS resources may be configured at the UE, and one or multiple indicators in the control information may be mapped to SRS resources of one or more of the sets of SRS resources.

### CROSS REFERENCE

The present Application for Patent claims the benefit of U.S. Provisional Patent Application No. 63/131,161 by KHOSHNEVISAN et al., entitled “RESOURCE SIGNALING TECHNIQUES FOR MULTIPLE REPETITIONS OF UPLINK TRANSMISSIONS,” filed Dec. 28, 2020, assigned to the assignee hereof, and expressly incorporated by reference herein.

### FIELD OF TECHNOLOGY

The following relates to wireless communication, including resource signaling techniques for multiple repetitions of uplink transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support communications using one or multiple antenna arrays at different devices. For instance, a network may communicate with a UE using one or more transmission-reception points (TRPs), where each TRP and the UE may have one or more antenna arrays to form directional beams. Efficient communications between UEs and one or multiple TRPs may help to enhance network throughput, latency, and reliability, and thus techniques to further improve efficient communications are desirable.

### SUMMARY

The described techniques relate to improved methods, systems, devices, and apparatuses that support resource signaling techniques for multiple repetitions of uplink transmissions. Various aspects provide techniques for communications between a user equipment (UE) and multiple transmission-reception points (TRPs) in which the UE may transmit multiple repetitions of an uplink communication to one or multiple TRPs to enhance the likelihood of successful receipt of the uplink communication. In some cases, the UE may transmit uplink communications based on parameters (e.g., a number of antenna ports, a spatial domain filter or beam, a rank or number of layers, or any combinations thereof) that are determined from a sounding reference signal (SRS) resource. The SRS resource may be selected from a set of SRS resources that are configured at the UE, and the SRS resource may be indicated in control information provided to the UE. In some cases, multiple sets of SRS resources may be configured at the UE, and one or multiple indicators in the control information (e.g., downlink control information (DCI)) may be mapped to SRS resources of one or more of the sets of SRS resources.

In some cases, a base station or TRP may transmit configuration information to a UE that indicates whether a control information transmission (e.g., a DCI) is to include one or two resource indications. Based on the configuration information, the UE may receive the control information, and determine one or two sets of SRS resources based on the one or two configured resource indications. The one or two sets of SRS resources may be associated with different repetitions of an uplink communication, such as a first set of repetitions that are transmitted to a first TRP and a second set of repetitions that are transmitted to a second TRP. In some cases, the UE may be configured to receive control information that includes two resource indications, and may identify particular SRS resources within one or two sets of SRS resources based on an associated indicator (e.g., based on a mapping between each indicator and SRS resources of an associated set of SRS resources). In other cases, the UE may be configured to receive control information that includes one resource indication, and may identify particular SRS resources within one or two sets of SRS resources based on the one resource indication (e.g., based on a mapping between an indicator and SRS resources of each sets of SRS resources).

A method for wireless communication at a UE is described. The method may include receiving, from a base station, SRS configuration information that indicates whether control information that provides an uplink grant to the UE is to include one resource indicator for SRS resources or two resource indicators for SRS resources, receiving first control information that schedules two or more repetitions of a first uplink communication and that indicates an association between the two or more repetitions of the first uplink communication with either a first set of SRS resources, a second set of SRS resources, or both, determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and transmitting the first set of repetitions of the first uplink communication using the first set of uplink transmission parameters and the second set of repetitions of the first uplink communication using the second set of uplink transmission parameters.

An apparatus for wireless communication at a UE is described. The apparatus may include a processor, memory in electronic communication with the processor, and instructions stored in the memory. The instructions may be executable by the processor to cause the apparatus to receive, from a base station, SRS configuration information that indicates whether control information that provides an uplink grant to the UE is to include one resource indicator for SRS resources or two resource indicators for SRS resources, receive first control information that schedules two or more repetitions of a first uplink communication and that indicates an association between the two or more repetitions of the first uplink communication with either a first set of SRS resources, a second set of SRS resources, or both, determine a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and transmit the first set of repetitions of the first uplink communication using the first set of uplink transmission parameters and the second set of repetitions of the first uplink communication using the second set of uplink transmission parameters.

Another apparatus for wireless communication at a UE is described. The apparatus may include means for receiving, from a base station, SRS configuration information that indicates whether control information that provides an uplink grant to the UE is to include one resource indicator for SRS resources or two resource indicators for SRS resources, means for receiving first control information that schedules two or more repetitions of a first uplink communication and that indicates an association between the two or more repetitions of the first uplink communication with either a first set of SRS resources, a second set of SRS resources, or both, means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and means for transmitting the first set of repetitions of the first uplink communication using the first set of uplink transmission parameters and the second set of repetitions of the first uplink communication using the second set of uplink transmission parameters.

A non-transitory computer-readable medium storing code for wireless communication at a UE is described. The code may include instructions executable by a processor to receive, from a base station, SRS configuration information that indicates whether control information that provides an uplink grant to the UE is to include one resource indicator for SRS resources or two resource indicators for SRS resources, receive first control information that schedules two or more repetitions of a first uplink communication and that indicates an association between the two or more repetitions of the first uplink communication with either a first set of SRS resources, a second set of SRS resources, or both, determine a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and transmit the first set of repetitions of the first uplink communication using the first set of uplink transmission parameters and the second set of repetitions of the first uplink communication using the second set of uplink transmission parameters.

In some examples of the method, apparatuses, and non-transitory computer-readable medium described herein, the first set of SRS resources are associated with the first set of repetitions of the first uplink communication and the second set of SRS resources are associated with the second set of repetitions of the first uplink communication, and where the first set of repetitions of the first uplink communication are transmitted to a first TRP and the second set of repetitions of the first uplink communication are transmitted to a second TRP.

In some examples of the method, apparatuses, and non-transitory computer-readable medium described herein, the first set of repetitions of the first uplink communication and the second set of repetitions of the first uplink communication may be codebook-based or non-codebook-based physical uplink shared channel transmissions. In some examples of the method, apparatuses, and non-transitory computer-readable medium described herein, the receiving the first control information may include operations, features, means, or instructions for decoding a first resource indictor in the first control information that provides a first SRS resource of the first set of SRS resources and decoding a second resource indicator in the first control information that provides a second SRS resource of the second set of SRS resources.

In some examples of the method, apparatuses, and non-transitory computer-readable medium described herein, the SRS configuration information indicates that the first control information is to include the two resource indicators for SRS resources and the method, apparatuses, and non-transitory computer-readable medium may include further operations, features, means, or instructions for identifying that the first control information indicates that a single SRS resource set is associated with the first uplink communication, determining both the first set of uplink transmission parameters and the second set of uplink transmission parameters based on a first resource indicator in the first control information, and ignoring a second resource indicator in the first control information.

In some examples of the method, apparatuses, and non-transitory computer-readable medium described herein, the SRS configuration information indicates that the first control information is to include the two resource indicators for SRS resources and the method, apparatuses, and non-transitory computer-readable medium may include further operations, features, means, or instructions for identifying that the first control information indicates that two SRS resource sets are associated with the first uplink communication, determining the first set of uplink transmission parameters based on a first resource indicator of the two resource indicators in the first control information, and determining the second set of uplink transmission parameters based on a second resource indicator of the two resource indicators in the first control information.

In some examples of the method, apparatuses, and non-transitory computer-readable medium described herein, the SRS configuration information indicates that the first control information is to include a single resource indicator for SRS resources, and where both the first set of uplink transmission parameters and the second set of uplink transmission parameters are determined based on the single resource indicator in the first control information.

Some examples of the method, apparatuses, and non-transitory computer-readable medium described herein may further include operations, features, means, or instructions for identifying that the first control information indicates that a single SRS resource set is associated with the first uplink communication and determining both the first set of uplink transmission parameters and the second set of uplink transmission parameters based on the single resource indicator in the first control information and the single SRS resource set.

Some examples of the method, apparatuses, and non-transitory computer-readable medium described herein may further include operations, features, means, or instructions for identifying that the first control information indicates that two SRS resource sets are associated with the first uplink communication, determining the first set of uplink transmission parameters based on the single resource indicator in the first control information and a first mapping between the single resource indicator and SRS resources of a first SRS resource set, and determining the second set of uplink transmission parameters based on the single resource indicator in the first control information and a second mapping between the single resource indicator and SRS resources of a second SRS resource set.

In some examples of the method, apparatuses, and non-transitory computer-readable medium described herein, the SRS configuration information separately configures two or more different control information formats to include the one resource indicator for SRS resources or the two resource indicators for SRS resources.

In some examples of the method, apparatuses, and non-transitory computer-readable medium described herein, the first set of repetitions of the first uplink communication and the second set of repetitions of the first uplink communication are codebook-based physical uplink shared channel transmissions and one SRS resource within each set of SRS resources is indicated for each codebook-based resource indicator, or the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

In some examples of the method, apparatuses, and non-transitory computer-readable medium described herein, the first set of repetitions of the first uplink communication and the second set of repetitions of the first uplink communication are codebook-based physical uplink shared channel transmissions and the SRS configuration information indicates that the first control information is to include the two resource indicators for SRS resources, and where each of the two resource indicators are mapped to SRS resources within the associated set of SRS resources that have a same number of antenna ports.

In some examples of the method, apparatuses, and non-transitory computer-readable medium described herein, the first set of repetitions of the first uplink communication and the second set of repetitions of the first uplink communication are codebook-based physical uplink shared channel transmissions and the SRS configuration information indicates that the first control information is to include the two resource indicators for SRS resources, and where an i-th configured SRS resource of a first SRS resource set has a same number of antenna ports as an i-th configured SRS resource of a second SRS resource set.

In some examples of the method, apparatuses, and non-transitory computer-readable medium described herein, the first set of repetitions of the first uplink communication and the second set of repetitions of the first uplink communication are non-codebook-based physical uplink shared channel transmissions and the SRS configuration information indicates that the first control information is to include the two resource indicators for SRS resources, and where a first quantity of indicated SRS resources within the first set of SRS resources is a same quantity as a second quantity of indicated SRS resources within the second set of SRS resources.

In some examples of the method, apparatuses, and non-transitory computer-readable medium described herein, the SRS configuration information indicates that the first control information is to include a single resource indicator for SRS resources within the first set of SRS resources and the second set of SRS resources, and the first set of SRS resources and the second set of SRS resources have a same number of SRS resources, or a number of bits in the single resource indicator is determined based on a maximum number of SRS resources of the first set of SRS resources or the second set of SRS resources.

In some examples of the method, apparatuses, and non-transitory computer-readable medium described herein, the receiving the first control information may include operations, features, means, or instructions for identifying a two-bit field within the first control information that indicates that the first uplink communication is to use the first set of SRS resources only, is to use the second set of SRS resources only, or is to use both the first set of SRS resources and the second set of SRS resources and determine which set of repetitions of the first uplink communication is to use the first set of SRS resources and that the other set of repetitions is to use the second set of SRS resources.

In some examples of the method, apparatuses, and non-transitory computer-readable medium described herein, the receiving the first control information may include operations, features, means, or instructions for identifying a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources.

In some examples of the method, apparatuses, and non-transitory computer-readable medium described herein, the first bit value provides a predetermined indication that the first uplink communication is to use the first set of SRS resources, the first bit value is configured by the SRS configuration information to indicate that the first uplink communication is to use the first set of SRS resources, or the first bit value indicates that a different information field in the first control information provides an indication that the first uplink communication is to use either the first set of SRS resources or the second set of SRS resources. In some examples of the method, apparatuses, and non-transitory computer-readable medium described herein, an indication that one of the first set of SRS resources or the second set of SRS resources is unused is provided by a reserved value of a resource indication of the associated set of SRS resources.

A method for wireless communication at a base station is described. The method may include transmitting, to a UE, SRS configuration information that indicates whether control information that provides an uplink grant to the UE is to include one resource indicator for SRS resources or two resource indicators for SRS resources, transmitting first control information to the UE that schedules two or more repetitions of a first uplink communication and that indicates an association between the two or more repetitions of the first uplink communication with either a first set of SRS resources, a second set of SRS resources, or both, determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and receiving the first set of repetitions of the first uplink communication using the first set of uplink transmission parameters and the second set of repetitions of the first uplink communication using the second set of uplink transmission parameters.

An apparatus for wireless communication at a base station is described. The apparatus may include a processor, memory in electronic communication with the processor, and instructions stored in the memory. The instructions may be executable by the processor to cause the apparatus to transmit, to a UE, SRS configuration information that indicates whether control information that provides an uplink grant to the UE is to include one resource indicator for SRS resources or two resource indicators for SRS resources, transmit first control information to the UE that schedules two or more repetitions of a first uplink communication and that indicates an association between the two or more repetitions of the first uplink communication with either a first set of SRS resources, a second set of SRS resources, or both, determine a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and receive the first set of repetitions of the first uplink communication using the first set of uplink transmission parameters and the second set of repetitions of the first uplink communication using the second set of uplink transmission parameters.

Another apparatus for wireless communication at a base station is described. The apparatus may include means for transmitting, to a UE, SRS configuration information that indicates whether control information that provides an uplink grant to the UE is to include one resource indicator for SRS resources or two resource indicators for SRS resources, means for transmitting first control information to the UE that schedules two or more repetitions of a first uplink communication and that indicates an association between the two or more repetitions of the first uplink communication with either a first set of SRS resources, a second set of SRS resources, or both, means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and means for receiving the first set of repetitions of the first uplink communication using the first set of uplink transmission parameters and the second set of repetitions of the first uplink communication using the second set of uplink transmission parameters.

A non-transitory computer-readable medium storing code for wireless communication at a base station is described. The code may include instructions executable by a processor to transmit, to a UE, SRS configuration information that indicates whether control information that provides an uplink grant to the UE is to include one resource indicator for SRS resources or two resource indicators for SRS resources, transmit first control information to the UE that schedules two or more repetitions of a first uplink communication and that indicates an association between the two or more repetitions of the first uplink communication with either a first set of SRS resources, a second set of SRS resources, or both, determine a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication, and receive the first set of repetitions of the first uplink communication using the first set of uplink transmission parameters and the second set of repetitions of the first uplink communication using the second set of uplink transmission parameters.

In some examples of the method, apparatuses, and non-transitory computer-readable medium described herein, the first set of SRS resources is associated with the first set of repetitions of the first uplink communication and the second set of SRS resources is associated with the second set of repetitions of the first uplink communication, and where the first set of repetitions of the first uplink communication is transmitted to a first TRP and the second set of repetitions of the first uplink communication is transmitted to a second TRP. In some examples of the method, apparatuses, and non-transitory computer-readable medium described herein, the first set of repetitions of the first uplink communication and the second set of repetitions of the first uplink communication are codebook-based or non-codebook-based physical uplink shared channel transmissions.

In some examples of the method, apparatuses, and non-transitory computer-readable medium described herein, the transmitting the first control information may include operations, features, means, or instructions for transmitting a first resource indictor in the first control information that provides a first SRS resource of the first set of SRS resources and transmitting a second resource indicator in the first control information that provides a second SRS resource of the second set of SRS resources.

In some examples of the method, apparatuses, and non-transitory computer-readable medium described herein, the SRS configuration information indicates that the first control information is to include the two resource indicators for SRS resources, the first control information indicates that a single SRS resource set is associated with the first uplink communication, and both the first set of uplink transmission parameters and the second set of uplink transmission parameters based on a first resource indicator in the first control information irrespective of a value of a second resource indicator in the first control information.

In some examples of the method, apparatuses, and non-transitory computer-readable medium described herein, the SRS configuration information indicates that the first control information is to include the two resource indicators for SRS resources and the method, apparatuses, and non-transitory computer-readable medium may include further operations, features, means, or instructions for transmitting an indication in the first control information that two SRS resource sets are associated with the first uplink communication, and where the first set of uplink transmission parameters is based on a first resource indicator of the two resource indicators in the first control information, and the second set of uplink transmission parameters is based on a second resource indicator of the two resource indicators in the first control information.

In some examples of the method, apparatuses, and non-transitory computer-readable medium described herein, the SRS configuration information indicates that the first control information is to include a single resource indicator for SRS resources, and where both the first set of uplink transmission parameters and the second set of uplink transmission parameters are determined based on the single resource indicator in the first control information.

Some examples of the method, apparatuses, and non-transitory computer-readable medium described herein may further include operations, features, means, or instructions for transmitting, in the first control information, an indication that a single SRS resource set is associated with the first uplink communication, and where both the first set of uplink transmission parameters and the second set of uplink transmission parameters are based on the single resource indicator in the first control information and the single SRS resource set.

Some examples of the method, apparatuses, and non-transitory computer-readable medium described herein may further include operations, features, means, or instructions for transmitting, in the first control information, an indication that two SRS resource sets are associated with the first uplink communication, and where the first set of uplink transmission parameters are based on the single resource indicator in the first control information and a first mapping between the single resource indicator and SRS resources of a first SRS resource set; and the second set of uplink transmission parameters are based on the single resource indicator in the first control information and a second mapping between the single resource indicator and SRS resources of a second SRS resource set. In some examples of the method, apparatuses, and non-transitory computer-readable medium described herein, the SRS configuration information separately configures two or more different control information formats to include the one resource indicator for SRS resources or the two resource indicators for SRS resources.

In some examples of the method, apparatuses, and non-transitory computer-readable medium described herein, the first set of repetitions of the first uplink communication and the second set of repetitions of the first uplink communication are codebook-based physical uplink shared channel transmissions and one SRS resource within each set of SRS resources is indicated for each codebook-based resource indicator, or the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

In some examples of the method, apparatuses, and non-transitory computer-readable medium described herein, the first set of repetitions of the first uplink communication and the second set of repetitions of the first uplink communication are codebook-based physical uplink shared channel transmissions and the SRS configuration information indicates that the first control information is to include the two resource indicators for SRS resources, and where each of the two resource indicators are mapped to SRS resources within the associated set of SRS resources that has a same number of antenna ports.

In some examples of the method, apparatuses, and non-transitory computer-readable medium described herein, the first set of repetitions of the first uplink communication and the second set of repetitions of the first uplink communication are codebook-based physical uplink shared channel transmissions and the SRS configuration information indicates that the first control information is to include the two resource indicators for SRS resources, and where an i-th configured SRS resource of a first SRS resource set has a same number of antenna ports as an i-th configured SRS resource of a second SRS resource set.

In some examples of the method, apparatuses, and non-transitory computer-readable medium described herein, the first set of repetitions of the first uplink communication and the second set of repetitions of the first uplink communication are non-codebook-based physical uplink shared channel transmissions and the SRS configuration information indicates that the first control information is to include the two resource indicators for SRS resources, and where a first quantity of indicated SRS resources within the first set of SRS resources is a same quantity as a second quantity of indicated SRS resources within the second set of SRS resources.

In some examples of the method, apparatuses, and non-transitory computer-readable medium described herein, the SRS configuration information indicates that the first control information is to include a single resource indicator for SRS resources within the first set of SRS resources and the second set of SRS resources, and the first set of SRS resources and the second set of SRS resources have a same number of SRS resources, or a number of bits in the single resource indicator is determined based on a maximum number of SRS resources of the first set of SRS resources or the second set of SRS resources.

In some examples of the method, apparatuses, and non-transitory computer-readable medium described herein, the transmitting the first control information may include operations, features, means, or instructions for transmitting a two-bit field within the first control information that indicates that the first uplink communication is to use the first set of SRS resources only, is to use the second set of SRS resources only, or that the UE is to use both the first set of SRS resources and the second set of SRS resources and determine which set of repetitions of the first uplink communication is to use the first set of SRS resources and that the other set of repetitions is to use the second set of SRS resources.

In some examples of the method, apparatuses, and non-transitory computer-readable medium described herein, the transmitting the first control information may include operations, features, means, or instructions for transmitting a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources.

In some examples of the method, apparatuses, and non-transitory computer-readable medium described herein, the first bit value provides a predetermined indication that the first uplink communication is to use the first set of SRS resources, the first bit value is configured with the SRS configuration information to indicate that the first uplink communication is to use the first set of SRS resources, or the first bit value indicates that a different information field in the first control information provides an indication that the first uplink communication is to use either the first set of SRS resources or the second set of SRS resources. In some examples of the method, apparatuses, and non-transitory computer-readable medium described herein, an indication that one of the first set of SRS resources or the second set of SRS resources is unused may be provided by a reserved value of a resource indication of the associated set of SRS resources.

### BRIEF DESCRIPTION OF THE DRAWINGS

FIG. 1 illustrates an example of a wireless communications system that supports resource signaling techniques for multiple repetitions of uplink transmissions in accordance with aspects of the present disclosure.

FIG. 2 illustrates an example of a portion of a wireless communications system with multiple transmission-reception points (TRPs) that supports resource signaling techniques for multiple repetitions of uplink transmissions in accordance with aspects of the present disclosure.

FIG. 3 illustrates an example of control and shared channel communications that supports resource signaling techniques for multiple repetitions of uplink transmissions in accordance with aspects of the present disclosure.

FIG. 4 illustrates an example of control information with multiple resource indicators that supports resource signaling techniques for multiple repetitions of uplink transmissions in accordance with aspects of the present disclosure.

FIG. 5 illustrates an example of a control information with a single resource indicator that supports resource signaling techniques for multiple repetitions of uplink transmissions in accordance with aspects of the present disclosure.

FIG. 6 illustrates an example of a process flow that supports resource signaling techniques for multiple repetitions of uplink transmissions in accordance with aspects of the present disclosure.

FIGS. 7 and 8 show block diagrams of devices that support resource signaling techniques for multiple repetitions of uplink transmissions in accordance with aspects of the present disclosure.

FIG. 9 shows a block diagram of a communications manager that supports resource signaling techniques for multiple repetitions of uplink transmissions in accordance with aspects of the present disclosure.

FIG. 10 shows a diagram of a system including a device that supports resource signaling techniques for multiple repetitions of uplink transmissions in accordance with aspects of the present disclosure.

FIGS. 11 and 12 show block diagrams of devices that support resource signaling techniques for multiple repetitions of uplink transmissions in accordance with aspects of the present disclosure.

FIG. 13 shows a block diagram of a communications manager that supports resource signaling techniques for multiple repetitions of uplink transmissions in accordance with aspects of the present disclosure.

FIG. 14 shows a diagram of a system including a device that supports resource signaling techniques for multiple repetitions of uplink transmissions in accordance with aspects of the present disclosure.

FIGS. 15 through 24 show flowcharts illustrating methods that support resource signaling techniques for multiple repetitions of uplink transmissions in accordance with aspects of the present disclosure.

### DETAILED DESCRIPTION

In some wireless communications systems, the network may communicate with a user equipment (UE) using one or more transmission-reception points (TRPs). For example, the network may communicate with the UE using a single TRP at a base station, using multiple TRPs at a same base station, or using multiple TRPs across multiple base stations. In such systems, transmission parameters of each device (e.g., each UE, each TRP, each base station) may vary across the system (e.g., because different operating frequencies, different beams, different numbers of antenna ports, etc.), and thus separate parameters may be indicated for communications with different TRPs. For example, in a multi-TRP system, two or more TRPs may coordinate and configure a UE to transmit multiple sets of repetitions of an uplink communication in which one set of repetitions are directed to a first TRP and a different set of repetitions are directed to a second TRP. Such techniques may enhance the likelihood of at least one of the TRPs successfully receiving the uplink communication, and thus enhance communications reliability. However, when uplink transmissions to different TRPs have different transmission parameters, flexibility in providing an indication of the different transmission parameters may be desired in order to provide sufficient information to the UE for the different sets of repetitions of the communication. Existing configuration and control information techniques may not provide sufficient information for multiple different sets of repetitions of an uplink communication in some cases. Various aspects of the present disclosure provide enhanced techniques that allow for flexible and efficient signaling of configuration and control information associated with multiple TRPs.

In some cases, the UE may transmit uplink communications based on parameters (e.g., a number of antenna ports, a spatial domain filter or beam, a rank or number of layers, or any combinations thereof) that are determined from a sounding reference signal (SRS) resource. The SRS resource may be selected from a set of SRS resources that are configured at the UE, and may be indicated in control information provided to the UE. In some cases, multiple sets of SRS resources may be configured at the UE, and one or multiple indicators in the control information (e.g., downlink control information (DCI)) may be mapped to SRS resources of one or more of the sets of SRS resources.

In some deployments, SRS resources may be used to indicate uplink shared channel (e.g., physical uplink shared channel (PUSCH)) transmission parameters as well as SRS transmission parameters. In some cases, two types of PUSCH transmissions are supported, namely codebook and non-codebook PUSCH transmissions. In codebook based transmissions, a UE can be configured with one SRS resource set with “usage” set to “codebook.” A maximum of four SRS resources within the SRS resource set can be configured for the UE, and each SRS resource in such cases may be configured (e.g., via radio resource control (RRC) signaling) with a number of ports (e.g., nrofSRS-Ports). An SRS resource indicator (SRI) field in DCI that schedules the PUSCH transmission may indicate one SRS resource. In such cases, a number of ports configured for the indicated SRS resource determines number of antenna ports for PUSCH, and the PUSCH is transmitted with the same spatial domain filter (e.g., beam) as the indicated SRS resources. Further, for such codebook PUSCH transmissions, a number of transmission layers (rank) and transmitted precoder matrix indicator (TPMI) for the scheduled PUSCH may be determined from a separate DCI field (e.g., a “Precoding information and number of layers” field). For example, a same number of transmission layers may be applied to two TMPIs if the two TMPIs are indicated. The SRI may include a bit field that is mapped to an index of configured SRS resources in the SRS resource set, where a size of the bit field is based on a number of configured SRS resources in the SRS resource set.

For non-codebook based uplink transmissions, a UE may be configured with one SRS resource set with “usage” set to “noncodebook.” In such cases, a maximum of four SRS resources within the SRS resource set can be configured for the UE, and each SRS resource has one port. The SRI field in the uplink DCI (e.g., that schedules PUSCH) indicates one or multiple SRS resources, and the number of indicated SRS resources determines the rank (e.g., number of layers) for the scheduled PUSCH. The PUSCH communication is transmitted with a same precoder as well as spatial domain filter (e.g., beam) as the indicated SRS resources. The SRI may include a bit field that is mapped to an index of configured SRS resources in the SRS resource set, where a size of the bit field is based on a number of configured SRS resources in the SRS resource set and the number of layers of the PUSCH transmission.

In cases where multiple repetitions of an uplink communication are transmitted to multiple TRPs, it may be useful in some instances to configure multiple SRS resource sets, which may provide additional options for uplink transmission parameters for the multiple repetitions. For example, if a first link between a UE and a first TRP is blocked, a first repetition of an uplink transmission to the first TRP may not be successfully received. However, if a second link between the UE and a second TRP is not blocked, a second repetition of the uplink transmission to the second TRP may be successfully received and decoded. Thus, such techniques may increase diversity in communications and thereby enhance reliability and efficiency in cases where one or more links may experience relatively poor channel conditions. In some cases, different PUSCH transmission occasions (i.e., repetitions) corresponding to the same transport block (TB) are transmitted in different slots or mini-slots, and a number of repetitions may be configured (e.g., via RRC signaling) or may be indicated dynamically (e.g., in DCI that schedules the uplink communication, such as in a time domain resource assignment (TDRA) field).

In existing deployments, all of the repetitions are transmitted with the same beam (e.g., the SRI field of the DCI is applied to all the repetitions), and when different PUSCH repetitions are intended to be received at different TRPs, panels, antennas, or any combination thereof at the base station side, such a same beam for all the repetitions may not be well suited for receipt at each of the different TRPs, panels, antennas, or any combination thereof. In order to provide for different repetitions to be transmitted using different beams, in some cases, the multiple SRS resource sets may be configured such that different repetitions may use uplink transmission parameters associated with different SRS resources in different SRS resource sets. Further, in some cases, SRS resources within one SRS resource set may be sufficient to indicate suitable uplink transmission parameters, and various aspects of the present disclosure provide for flexibility in indications of one or multiple SRIs, and in mapping SRIs with SRS resources from one or multiple SRS resource sets. Such techniques may be used for codebook or non-codebook based uplink communications.

In accordance with techniques as discussed herein, a base station or TRP may configure multiple SRS resource sets, and transmit configuration information to a UE that indicates whether a control information transmission (e.g., a DCI) is to include one or two resource indications. Based on the configuration information, the UE may receive the control information, and determine one or two sets of SRS resources based on the configured resource indication(s). The one or two sets of SRS resources may be associated with different repetitions of an uplink communication, such as a first set of repetitions that are transmitted to a first TRP and a second set of repetitions that are transmitted to a second TRP. In some cases, the UE may be configured to receive control information that includes two resource indications, and may identify particular SRS resources within one or two sets of SRS resources based on an associated indicator (e.g., based on a mapping between each indicator and SRS resources of an associated set of SRS resources). In other cases, the UE may be configured to receive control information that includes one resource indication, and may identify particular SRS resources within one or two sets of SRS resources based on the one resource indication (e.g., based on a mapping between an indicator and SRS resources of each sets of SRS resources).

Aspects of the disclosure are initially described in the context of wireless communications systems. Aspects of the disclosure are further illustrated by and described with reference to SRS resources for multiple repetitions, process flow diagrams, apparatus diagrams, system diagrams, and flowcharts that relate to resource signaling techniques for multiple repetitions of uplink transmissions.

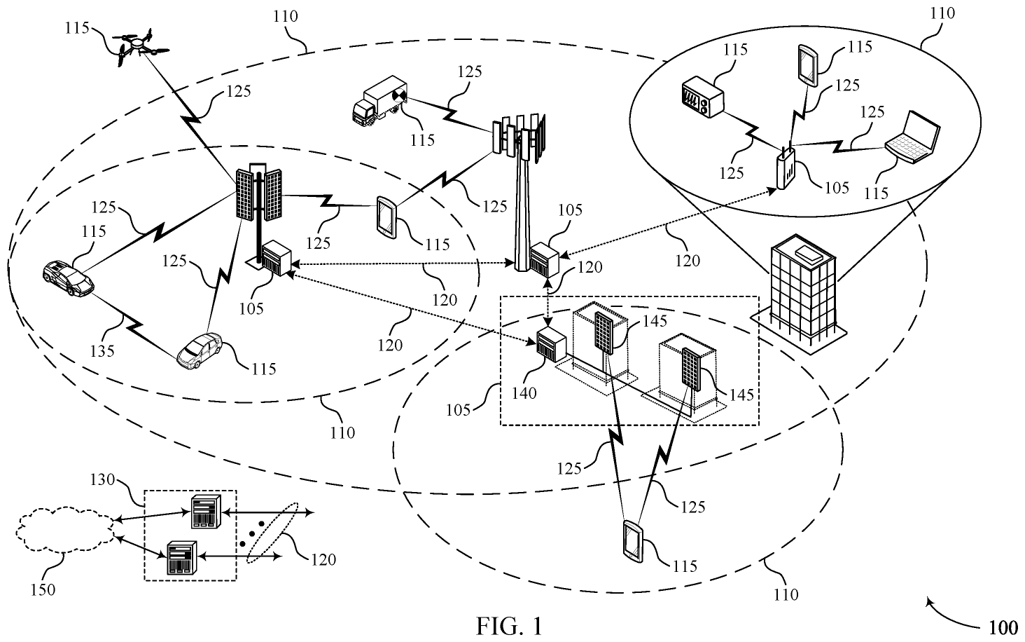

FIG. 1 illustrates an example of a wireless communications system 100 that supports resource signaling techniques for multiple repetitions of uplink transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

Additionally or alternatively, a base station 105 in the wireless communications system 100 may include one or more TRPs. Each TRP may be associated with one or more antenna ports, beams, and beam indices. In some cases, a UE 115 may transmit one or more uplink communications to multiple TRPs, and such communications may include multiple repetitions of an uplink communication to multiple TRPs to enhance the likelihood of successful receipt of the uplink communication. In some cases, the UE 115 may transmit uplink communications based on parameters (e.g., a number of antenna ports, a spatial domain filter or beam, a rank or number of layers, or any combinations thereof) that are determined from an SRS resource. The SRS resource may be selected from a set of SRS resources that are configured at the UE 115, and may be indicated in control information provided to the UE 115. In some cases, multiple sets of SRS resources may be configured at the UE 115, and one or multiple indicators in the control information may be mapped to SRS resources of one or more of the sets of SRS resources.

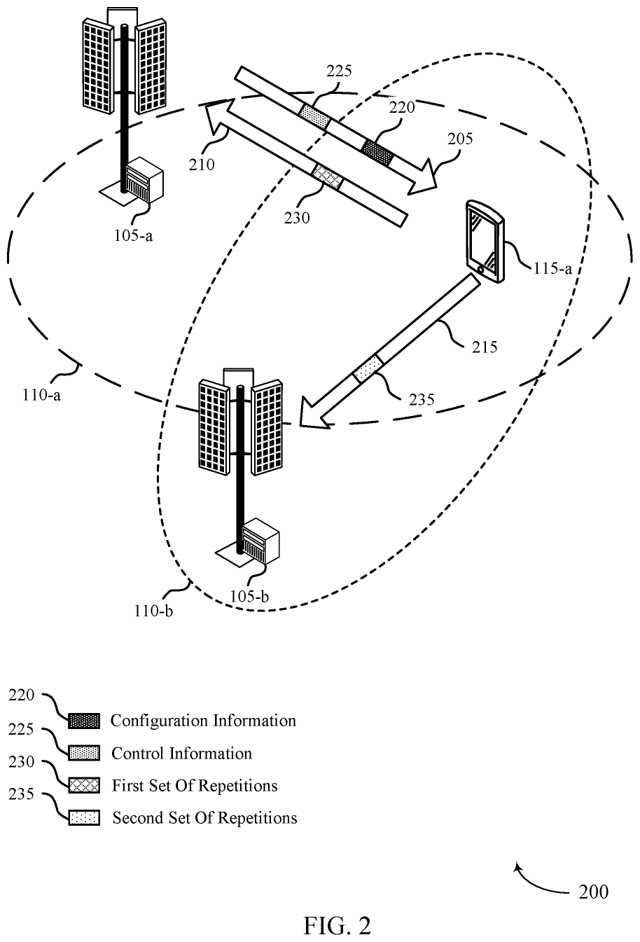

FIG. 2 illustrates an example of a wireless communications system 200 that supports resource signaling techniques for multiple repetitions of uplink transmissions in accordance with aspects of the present disclosure. For example, the wireless communications system 200 includes a first base station 105-a, a second base station 105-b, and a UE 115-a, which may be examples of the respective devices as described with reference to FIG. 1. It is to be understood that references to specific wireless devices (e.g., UEs, TRPs, base stations) in the below figures are provided for illustrative purposes, and different wireless devices not specifically referred to herein may be used interchangeably with those described herein. Likewise, the described operations performed by a UE 115 may, in some cases, be performed by a base station 105 (or TRP), and vice versa. In some examples, multiple TRPs may each be a standalone TRPs or may be part of one base station 105 or different base stations 105. Additionally or alternatively, the base stations 105 or TRPs may be a component of or an example of an IAB node, a repeater node (e.g., configured with some retransmission capability), or the like. Further, the UE 115-a may be an example of a customer premises equipment (CPE), a sidelink node, a repeater node, or the like.

The first base station 105-a (e.g., that is associated with a first TRP) may provide coverage area 110-a, and the second base station 105-b (e.g., that is associated with a second TRP) may provide coverage area 110-b. Additionally or alternatively, each base station 105 may communicate with the UE 115-a over one or multiple communication links. For example, the first base station 105-a may transmit downlink communications to the UE 115-a via link 205, and the UE 115-a may transmit uplink communications to the first base station 105-a via link 210. In this example, the UE 115-a may also transmit uplink communications to the second base station 105-b via link 215. In some examples, the base stations 105 and the UE 115-a may communicate using particular directional beams that are identified based on one or more beam training procedures.

In some cases, in order to allow for uplink communications to both of the base stations 105 the UE 115-a may be configured with two SRS resource sets. The multiple SRS resource sets may be provided for either codebook-based or non-codebook based communications, and SRS resources from one or both of the SRS resource sets may be indicated by one or two resource indication (e.g., SRI) fields that are transmitted to the UE 115-a in control information 225. In some cases, the UE 115-a may receive configuration information 220 that indicates whether a first resource indication, or whether both the first resource indication and a second resource indication, are present in the control information 225. For example, the configuration information 220 may be RRC signaled configuration information. The one or more resource indication fields may provide an indication of SRS resources within one or two SRS resource sets that provide uplink transmission parameters for a first set of repetitions 230 of an uplink communication and a second set of repetitions 235 of the uplink communication. In this example, the first set of repetitions 230 are transmitted to the first base station 105-a (e.g., to a first TRP at the first base station 105-a) and the second set of repetitions 235 are transmitted to the second base station 105-b (e.g., to a second TRP at the second base station 105-b).

As indicated, the UE 115-a may be configured by the configuration information 220 to expect one resource indication or to expect two resource indications (e.g., in one SRI field or in two SRI fields). In cases where two resource indications are configured, the UE 115-a may receive the control information 225 and determine that scheduling information for the uplink communication indicates one SRS resource set (e.g., indicates a first SRS resource set only). In such a case, the resource indication may indicate one or more SRS resources within the first SRS resource set, and the second resource indication field may be ignored. In such cases, uplink transmission parameters for both the first set of repetitions 230 and the second set of repetitions 235 are determined based on the first SRS resource set.

In other cases, the control information 225 may indicate two SRS resource sets, and the first resource indication field may indicate one or more SRS resources within the first SRS resource set, and the second resource indication field may indicate one or more SRS resources within the second SRS resource set. In such cases, uplink transmission parameters for the first set of repetitions 230 are determined based on the first resource indication of SRS resources within the first SRS resource set, and the second set of repetitions 235 are determined based on the second resource indication of SRS resources within the second SRS resource set.

As also indicated, in some cases the UE 115-a may be configured by the configuration information 220 to expect a single resource indication field (e.g., a first SRI field is configured, and the second SRI field is not configured) in the control information 225. In such cases, the control information 225 (e.g., an uplink DCI scheduling PUSCH repetition) may indicate one SRS resource set (e.g., indicates the first SRS resource set only), and the resource indication field may indicate one or more SRS resources within the first SRS resource set only. In other cases, the control information 225 may indicate two SRS resource sets, and two resource indication fields may indicate SRS resources from within the first SRS resource set and the second SRS resource set, respectively.

In some cases, the configuration of the presence of one or two resource indication fields may be separately configured for different control information 225 formats (e.g., via RRC signaling). That is, the two SRI fields corresponding to two SRS resource sets may be included in different DCI formats. In some examples, rather than being explicitly configured with the number of SRI fields the number of SRI fields may be dependent on the configuration of the number of configured SRS resource sets at the UE 115-a. If the UE 115-a is configured with two SRS resource sets and either or both of the SRS resource sets have greater than one SRS resource, then the DCI may include the two SRI fields. Thus, a rule for the number of SRI fields in the DCI may be dependent on the number of configured SRS resource sets and the number of configured SRS resources in each SRS resource set. Thus, if the number of SRS resource configuration (e.g., number of SRS resource sets and the number of SRS resources per set) is configured via SRS configuration information (e.g., via RRC signaling), the number of SRI fields in the DCI may be dependent/configured according to the SRS configuration For example, a first control information format that corresponds to DCI format 0_1 may be configured for one or two resource indication fields, and a second control information format that corresponds to DCI format 0_2 may be independently and separately configured for one or two resource indication fields. In some examples, each SRI field may indicate an SRI per TRP. The signaling of the resource indications may be used for codebook-based uplink communications, in which one SRS resource within an SRS resource set is indicated, and for non-codebook based uplink communications, in which one or more SRS resources within an SRS resource set may be indicated. In some examples, for non-codebook based uplink communications, the signaling of the resource indications may support a same number of layers applied over repetitions. Using such techniques, the presence of one or two resource indication fields may be configured semi-statically (e.g., via RRC signaling), while a single or multiple SRS resource sets for a particular uplink communication may be indicated dynamically in the control information 225. Additionally or alternatively, the described techniques may support dynamic switching between multi-TRP and single-TRP operations.

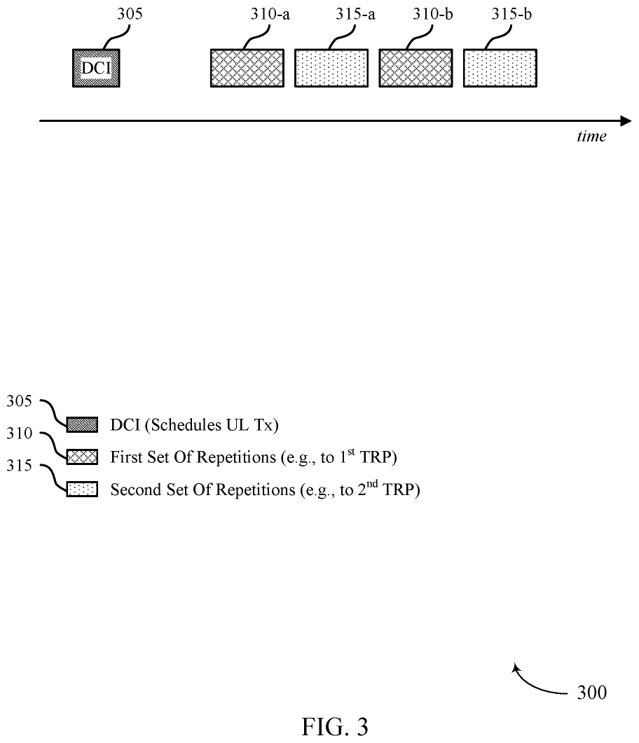

Such techniques may provide for configuration of multiple SRS resource sets at the UE 115-a, while allowing flexibility in scheduling uplink communications with repetitions that can use transmission parameters based on SRS resources from within one or both of the configured SRS resource sets. Thus, a base station 105 may select one or multiple SRS resource sets for repetitions of a particular PUSCH transmission based on beams that would be suitable for the different repetitions (e.g., if the identified beams are associated with TRPs that are associated with different SRS resource sets). Such selection and identification of SRS resource sets and SRS resources may allow a base station 105 to schedule uplink communications with repetitions based on channel conditions, and may enhance the likelihood of successful decoding of the uplink communication, and thereby enhance the efficiency and reliability of the wireless communications. Various examples and aspects are described in more detail with reference to FIGS. 3 through 6.

FIG. 3 illustrates an example of a control and shared channel communications 300 that supports resource signaling techniques for multiple repetitions of uplink transmissions in accordance with aspects of the present disclosure. For example, control and shared channel communications 300 may be used in wireless communications systems that include UEs 115 and base stations 105 as described with reference to FIGS. 1 and 2. It is to be understood that references to specific wireless devices (e.g., UEs, TRPs, base stations) in the exemplary figures are provided for illustrative purposes, and different wireless devices not specifically referred to herein may be used interchangeably with those described herein. Likewise, the described operations performed by a UE 115 may, in some cases, be performed by a base station 105, and vice versa. In some examples, the base stations may be examples of, or include, one or more TRPs. Additionally or alternatively, the base stations may each be an example of an IAB node, a repeater node (e.g., configured with some retransmission capability), or the like. Further, the UEs may be examples of a CPE, a sidelink node, a repeater node, or the like.

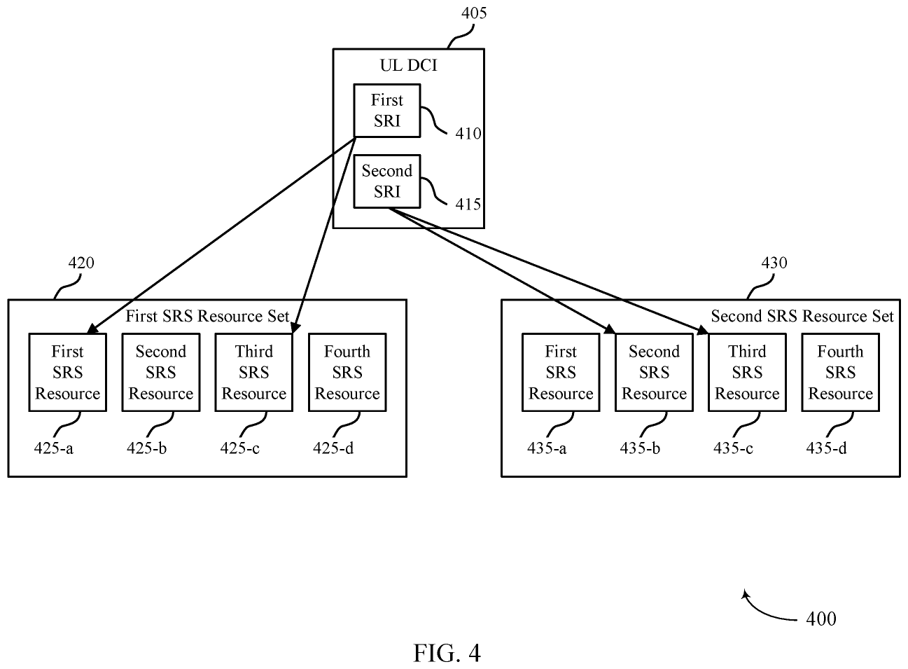

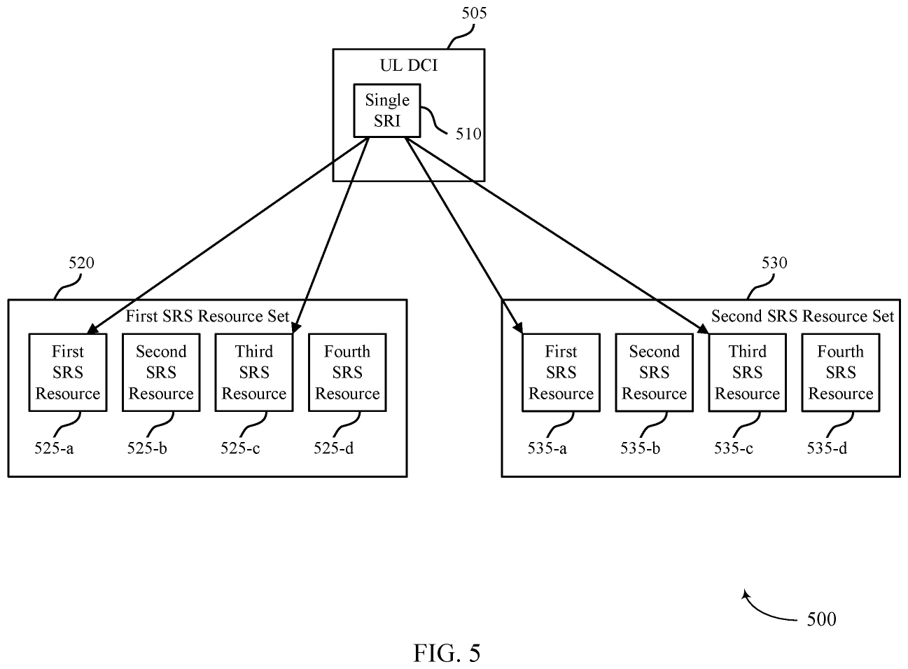

In this example, a scheduling DCI 305 may schedule an uplink transmission that has a first set of repetitions 310 and a second set of repetitions 315. Further, the first set of repetitions 310 may include a first repetition 310-a and a second repetition 310-b that are both transmitted to a first TRP. Likewise, the second set of repetitions 315 may include a third repetition 315-a and a fourth repetition 315-b that are both transmitted to a second TRP. Each repetition of both the first set of repetitions 310 and the second set of repetitions 315 may include a same TB, and thus the multiple repetitions to the multiple different TRPs may enhance the likelihood of successful decoding of the TB at either or both of the first and second TRPs. As discussed herein, the scheduling DCI 305 may include a single resource indication field, as will be discussed in more detail with reference to FIG. 5, or multiple resource indication fields, as will be discussed in more detail with reference to FIG. 4.

FIG. 4 illustrates an example of control information 400 with multiple resource indicators that supports resource signaling techniques for multiple repetitions of uplink transmissions in accordance with aspects of the present disclosure. For example, the control information 400 may be used in wireless communications systems that include UEs 115 and base stations 105 as described herein.

In this example, an uplink DCI 405 may include scheduling information for an uplink PUSCH communication from a UE to one or multiple TRPs. In this example, the UE may be configured (e.g., via RRC signaling) with two SRS resource sets, including a first SRS resource set 420 and a second SRS resource set 430. Further, the UE may be configured to expect control information with two SRI fields, which include a first SRI field 410 and a second SRI field 415. In this example, the first SRS resource set 420 may be configured with four SRS resources that include a first SRS resource 425-a, a second SRS resource 425-b, a third SRS resource 425-c, and a fourth SRS resource 425-d. Similarly, the second SRS resource set 430 may be configured with four SRS resources that include a first SRS resource 435-a, a second SRS resource 435-b, a third SRS resource 435-c, and a fourth SRS resource 435-d. The first SRI field 410 in this example indicates, within the first SRS resource set 420, the first SRS resource 425-a and the third SRS resource 425-c. The second SRI field 415 in this example indicates, within the second SRS resource set 430, the second SRS resource 435-b and the third SRS resource 435-c. Thus, in this example, the uplink communication may be transmitted in a first set of repetitions that use uplink transmission parameters based on the first SRI field 410 (e.g., that are suitable for transmissions to a first TRP using a first beam) and in a second set of repetitions that use uplink transmission parameter based on the second SRI field 415 (e.g., that are suitable for transmissions to a second TRP using a second beam).

In some cases, for codebook-based PUSCH, the UE may expect the indicated SRS resource (e.g., via the first SRI field 410) within the first SRS resource set 420 to have the same number of ports compared to the indicated SRS resource (e.g., via the second SRI field 415) within the second SRS resource set 430. In other cases, for non-codebook based PUSCH, the UE may expect the number of indicated SRS resources (e.g., via the first SRI field 410) within the first SRS resource set 420 to be the same as the number of indicated SRS resources (e.g., via the second SRI field 415) within the second SRS resource set 430. This provides that the two sets of PUSCH repetitions have the same rank, which may be determined by the number of indicated SRS resources within an SRS resource set. In some examples, for non-codebook based PUSCH (e.g., multi-TRP PUSCH), the first SRI field 410 may be used to determine an entry of the second SRI field 415 which may include at least one SRI combination corresponding to an indicated rank (e.g., number of layers) of the first SRI field 410. For example, a number of bits, N₂, for the second SRI field 415 may be determined by a maximum number of codepoints per rank among the ranks associated with the first SRI field 410. For each rank x, a first Kₓ codepoints may be mapped to Kₓ SRIs of rank x associated with the first SRI field 410, and the remaining (2^{N2}−Kₓ) codepoints may be reserved.

As discussed with reference to FIG. 2, in some cases the uplink DCI 405 may indicate one SRS resource set, or may indicate two SRS resource sets. As discussed, in the event that the uplink DCI 405 indicates one SRS resource set, the UE may ignore any indications provided in the second SRI field 415. In some cases, the indication of one SRS resource set versus two SRS resource sets in the uplink DCI 405 may be provided by a bit field within the uplink DCI 405. For example, such a bit field may include two bits that indicate one of the following three possibilities: (1) the first SRS resource set 420 only (e.g., all repetitions corresponding and targeted to a first TRP associated with the first SRS resource set 420); (2) the second SRS resource set 430 only (e.g., all repetitions corresponding and targeted to a second TRP associated with the second SRS resource set 430); or (3) both first SRS resource set 420 and the second SRS resource set 430 are to be used (e.g., two sets of repetitions corresponding and targeted to the first and second TRPs, respectively), and the UE is to which set of SRS resources corresponds to which SRI field.

In other examples, the bit field within the uplink DCI 405 that indicates one versus two SRS resource sets may be a one-bit field that indicates one SRS resource set or both SRS resource sets. In such cases, when the bit field indicates one SRS resource set, which of the first SRS resource set 420 or the second SRS resource set 430 is to be used may be based on an assumption that the first SRS resource set 420 (or the second SRS resource set 430) is used, or may be indicated to the UE with the configuration information (e.g., in RRC signaling). In further cases, a different bit field in the uplink DCI 405 may be used to determine whether the first SRS resource set 420 or the second SRS resource set 430 should be assumed. For example, if two SRI fields are present in the uplink DCI 405 and one of the SRI fields are not used (e.g., due to a single SRS resource set being indicated), then the second SRI field 415 may be used (e.g., the first or the last bit of that SRI field) to indicate whether the first SRS resource set 420 or the second SRS resource set 430 is indicated.

In other cases, a separate bit field with an indication of which SRS resource set is to be used in the event that one SRS resource set is indicated for an uplink communication may not be provided, and a reserved value for the SRI codepoint (e.g., all 0's or all 1's) may be used to indicate that an SRS resource set is not indicated (e.g., if the first SRI field 410 is set to all “0's,” no SRS resource is indicated from the first SRS resource set 420; if second SRI field 415 is set to all “0's,” no SRS resource is indicated from the second SRS resource set 430), and if a SRI field is not set to that reserved value, the value of the SRI field indicates one or more SRS resources within the corresponding SRS resource set (in such cases, the UE does not expect both SRI fields to be set to the reserved value).

FIG. 5 illustrates an example of control information 500 with a single resource indicator that supports resource signaling techniques for multiple repetitions of uplink transmissions in accordance with aspects of the present disclosure. For example, the control information 500 may be used in wireless communications systems that include UEs 115 and base stations 105 as described herein.

In this example, an uplink DCI 505 may include scheduling information for an uplink PUSCH communication from a UE to one or multiple TRPs. In this example, the UE may be configured (e.g., via RRC signaling) with two SRS resource sets, including a first SRS resource set 520 and a second SRS resource set 530. Further, the UE may be configured to expect control information with a single SRI field 510. In this example, the first SRS resource set 520 may be configured with four SRS resources that include a first SRS resource 525-a, a second SRS resource 525-b, a third SRS resource 525-c, and a fourth SRS resource 525-d. Similarly, the second SRS resource set 530 may be configured with four SRS resources that include a first SRS resource 535-a, a second SRS resource 535-b, a third SRS resource 535-c, and a fourth SRS resource 535-d. The single SRI field 510 in this example indicates, within both the first SRS resource set 520 and the second SRS resource set 530, the same relative SRS resources (e.g., first SRS resource 525-a and third SRS resource 525-c of the first SRS resource set 520, and first SRS resource 535-a and third SRS resource 535-c of the second SRS resource set 530). Thus, in this example, the uplink communication may be transmitted in a first set of repetitions that use uplink transmission parameters based on the first SRS resource set 520 and in a second set of repetitions that use uplink transmission parameter based on the second SRS resource set 530.

For codebook-based PUSCH, based on the single SRI field 510 that is configured in such cases, the UE may expect that the i-th configured SRS resource in the first SRS resource set 520 to have the same number of ports as the i-th SRS resource in the second SRS resource set 530. Such a configuration provides the two sets of PUSCH repetitions that have the same number of antennas ports (which is determined by the number of ports of the associated SRS resource).

In some examples, for both codebook-based and non-codebook based PUSCH, one of the following conditions is present. A first condition provides that the first SRS resource set 520 and the second SRS resource set 530 have the same number of SRS resources (e.g., ensured by configuration restrictions for the two SRS resource sets). A second condition provides that the number of bits of the single SRI field 510 of the uplink DCI 505 is determined based on the maximum of the number of SRS resources in the first SRS resource set 520 and the number of SRS resources in the second SRS resource set 530. Such conditions provide that the single SRI field 510 indicates the SRS resource(s) within both the first SRS resource set 520 and the second SRS resource set 530, while such conditions are may be unnecessary in cases where there are two separate SRI fields, as discussed with reference to FIG. 4.

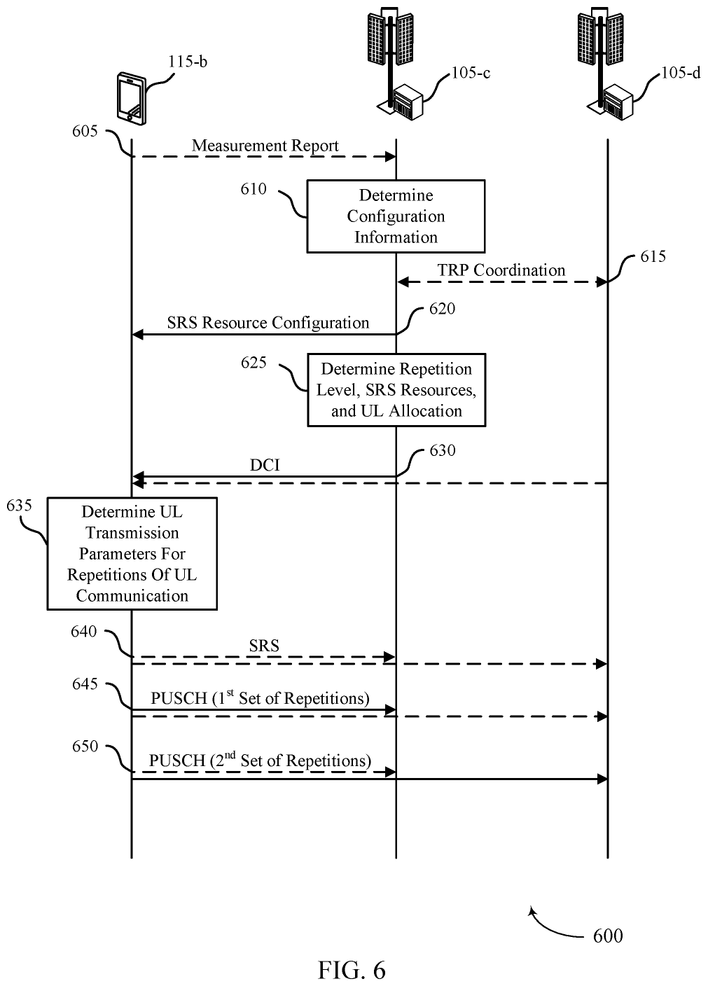

FIG. 6 illustrates an example of a process flow 600 that supports resource signaling techniques for multiple repetitions of uplink transmissions in accordance with aspects of the present disclosure. In some examples, the process flow 600 may implement aspects of wireless communications systems 100 or 200. For example, the process flow 600 includes a UE 115-b, a first base station 105-c, and a second base station 105-d that each may be examples of the corresponding devices described with reference to FIGS. 1-5. The process flow 600 may illustrate an example of the first base station 105-c, the second base station 105-d, and the UE 115-b determining uplink transmission parameters for multiple repetitions of an uplink communication to different TRPs.

In the following description of the process flow 600, the operations between the UE 115-b, the first base station 105-c, and the second base station 105-d may be transmitted in a different order than the order shown, or the operations performed by the UE 115-b, the first base station 105-c, and the second base station 105-d may be performed in different orders or at different times. Some operations may also be left out of the process flow 600, or other operations may be added to the process flow 600. It is to be understood that while the UE 115-b, the first base station 105-c, and the second base station 105-d are shown performing a number of the operations of process flow 600, any wireless device (e.g., a UE, a customer premises equipment, a base station, a TRP, an integrated access and backhaul (IAB) node, a repeater with different types of capabilities in terms of repetition of signals (also known as “smart” or “dumb” repeaters, or some other terminology), or a sidelink node, among other examples) may perform the operations shown.

Optionally, at 605, the UE 115-b may transmit a measurement report to the first base station 105-c (e.g., which may include a first TRP). Such a measurement report may provide information for one or more beams that are suitable for communications with the UE 115-b that are associated with one or more TRPs. In some cases, the measurement report may indicate that the UE 115-b is experiencing relatively poor channel conditions associated with one or more TRPs, which may indicate that multiple repetitions of uplink communications may be necessary to achieve a reliability target for communications.

At 610, the first base station 105-c may determine configuration information for the UE 115-b. In some cases, the first base station 105-c may be a serving base station and may determine that the UE 115-b is to transmit multiple repetitions of uplink communications. In some cases, the configuration information may include configuration of multiple SRS resource sets, which may each be associated with different TRPs (e.g., a first SRS resource set may provide SRS resources that are suitable for communications with one or multiple TRPs, and a second SRS resource set may provide SRS resources that are suitable for communications with one or multiple TRPs that may include some or none of the same TRPs as the first SRS resource set). The configuration information may also include an indication of whether control information that schedules uplink communications is to include one or two resource indicators (e.g., whether a scheduling DCI is to include one SRI field or is to include multiple SRI fields). Additionally or alternatively, the configuration information may also configure one of the SRS resource sets as being associated with a particular SRI field in control information. In some cases, the first base station 105-c may optionally exchange TRP coordination information with the second base station 105-d, as indicated at 615. Such coordination information may include information on uplink resources for expected uplink communications, for example.

At 620, the first base station 105-c may transmit SRS resource configuration to the UE 115-b. In some cases, the SRS resource configuration may be transmitted as part of RRC signaling between the UE 115-b and the first base station 105-c. At 625, the first base station 105-c may determine a repetition level, SRS resources, and an uplink allocation, for an uplink communication from the UE 115-b.

At 630, the first base station 105-c, the second base station 105-d, or both may transmit DCI to the UE 115-b. The DCI may include an indication of SRS resource set(s) that are to be used for an uplink communication, a number of repetitions of the uplink communication, an indication of one or more SRS resources within one or more SRS resource sets that are associate with the uplink communication, or any combinations thereof.

At 635, the UE 115-b may determine uplink transmission parameters for repetitions of the uplink communication. In some cases, the UE 115-b may determine which SRS resource of the configured SRS resource sets are to be associated with the uplink communication, such as by using one or more techniques as discussed herein.

Optionally, at 640, the UE 115-b may transmit one or more SRSs to the first base station 105-c, the second base station 105-d, or both. The one or more SRSs may have uplink transmission parameters that are determined based on the indicated SRS resources, as discussed herein. At 645, the UE 115-b may transmit a first set of PUSCH repetitions to the first base station 105-c (and optionally the second base station 105-d), and at 650 the UE 115-b may transmit a second set of PUSCH repetitions to the second base station 105-d (and optionally the first base station 105-c). The repetitions of the different sets of repetitions may have uplink transmission parameters that are determined based on the indicated SRS resources, such as by using various different techniques as provided herein.

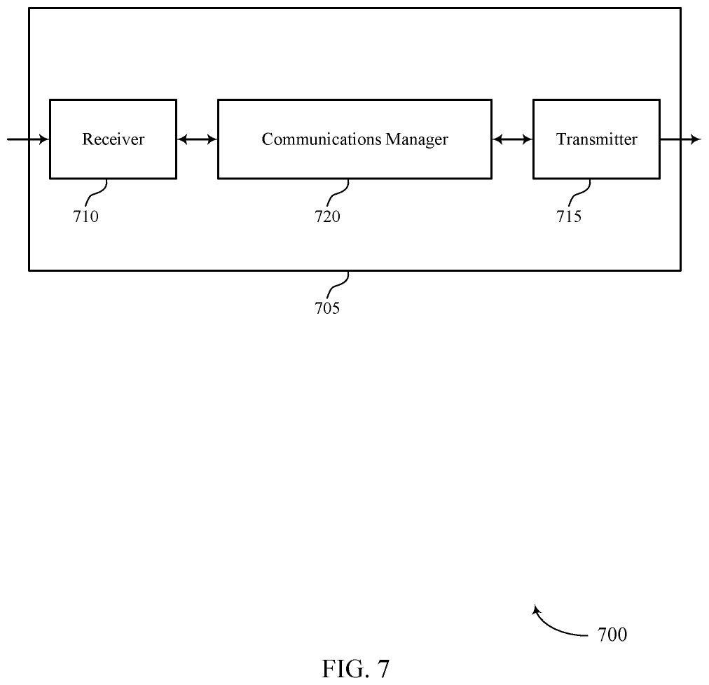

FIG. 7 shows a block diagram 700 of a device 705 that supports resource signaling techniques for multiple repetitions of uplink transmissions in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource signaling techniques for multiple repetitions of uplink transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource signaling techniques for multiple repetitions of uplink transmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of resource signaling techniques for multiple repetitions of uplink transmissions as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for receiving, from a base station, SRS configuration information that indicates whether control information that provides an uplink grant to the UE is to include one resource indicator for SRS resources or two resource indicators for SRS resources. The communications manager 720 may be configured as or otherwise support a means for receiving first control information that schedules two or more repetitions of a first uplink communication and that indicates an association between the two or more repetitions of the first uplink communication with either a first set of SRS resources, a second set of SRS resources, or both. The communications manager 720 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The communications manager 720 may be configured as or otherwise support a means for transmitting the first set of repetitions of the first uplink communication using the first set of uplink transmission parameters and the second set of repetitions of the first uplink communication using the second set of uplink transmission parameters.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for transmitting multiple repetitions of an uplink communication to multiple different TRPs, such that the different repetitions may use transmission parameters that are suitable for the particular TRP associated with the repetition. Such techniques may allow for enhanced reliability of wireless communications, and thus provide more efficient utilization of communication resources, reduced power consumption (through reduced retransmissions), reduced latency (through reduced retransmission), and more efficient utilization of communication resources.

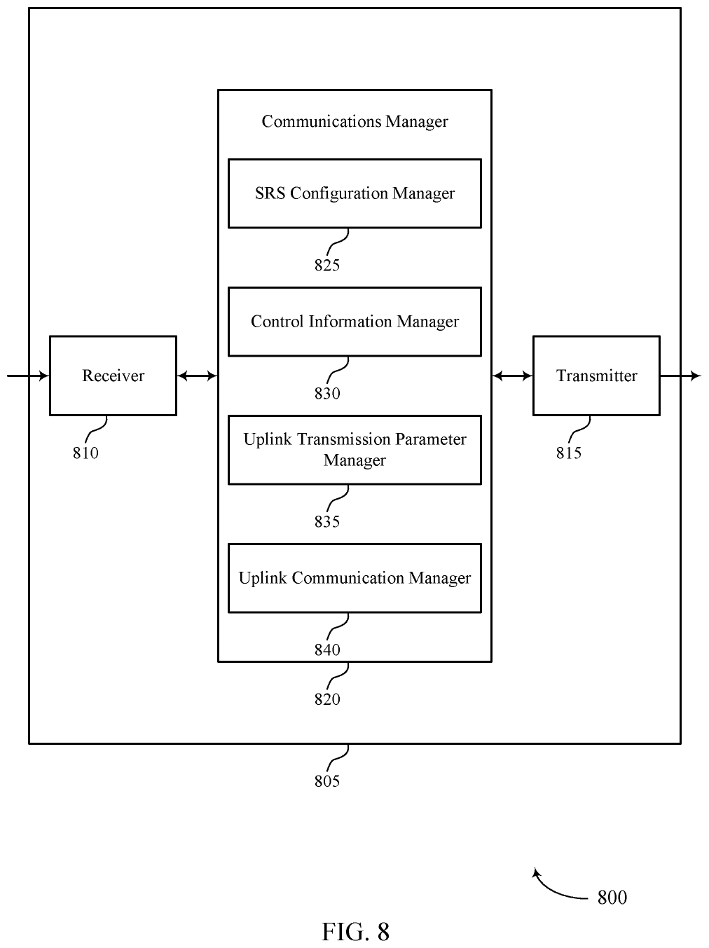

FIG. 8 shows a block diagram 800 of a device 805 that supports resource signaling techniques for multiple repetitions of uplink transmissions in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to resource signaling techniques for multiple repetitions of uplink transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to resource signaling techniques for multiple repetitions of uplink transmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of resource signaling techniques for multiple repetitions of uplink transmissions as described herein. For example, the communications manager 820 may include an SRS configuration manager 825, a control information manager 830, an uplink transmission parameter manager 835, an uplink communication manager 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The SRS configuration manager 825 may be configured as or otherwise support a means for receiving, from a base station, SRS configuration information that indicates whether control information that provides an uplink grant to the UE is to include one resource indicator for SRS resources or two resource indicators for SRS resources. The control information manager 830 may be configured as or otherwise support a means for receiving first control information that schedules two or more repetitions of a first uplink communication and that indicates an association between the two or more repetitions of the first uplink communication with either a first set of SRS resources, a second set of SRS resources, or both. The uplink transmission parameter manager 835 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The uplink communication manager 840 may be configured as or otherwise support a means for transmitting the first set of repetitions of the first uplink communication using the first set of uplink transmission parameters and the second set of repetitions of the first uplink communication using the second set of uplink transmission parameters.

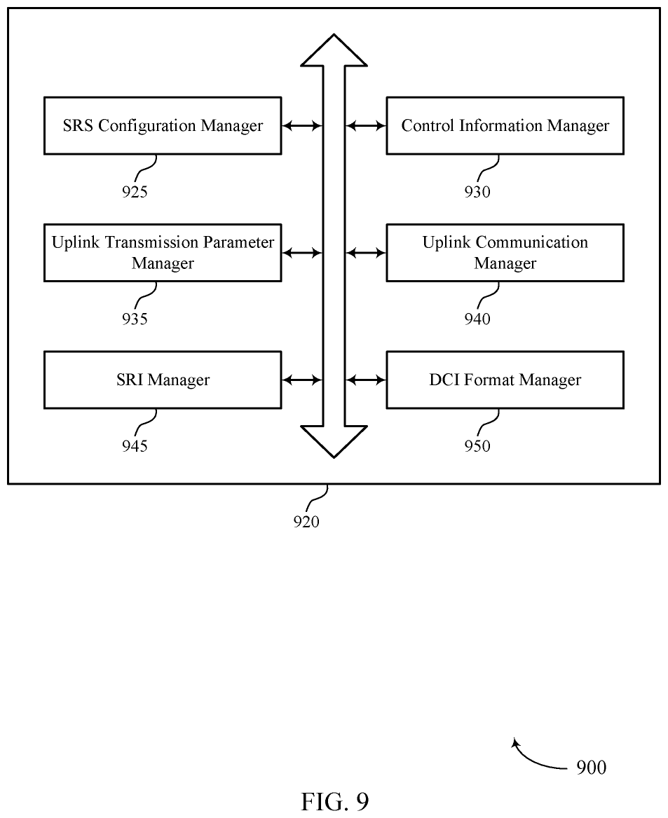

FIG. 9 shows a block diagram 900 of a communications manager 920 that supports resource signaling techniques for multiple repetitions of uplink transmissions in accordance with aspects of the present disclosure. The communications manager 920 may be an example of aspects of a communications manager 720, a communications manager 820, or both, as described herein. The communications manager 920, or various components thereof, may be an example of means for performing various aspects of resource signaling techniques for multiple repetitions of uplink transmissions as described herein. For example, the communications manager 920 may include an SRS configuration manager 925, a control information manager 930, an uplink transmission parameter manager 935, an uplink communication manager 940, an SRI manager 945, a DCI format manager 950, or any combination thereof. Each of these components may communicate, directly or indirectly, with one another (e.g., via one or more buses).

The communications manager 920 may support wireless communication at a UE in accordance with examples as disclosed herein. The SRS configuration manager 925 may be configured as or otherwise support a means for receiving, from a base station, SRS configuration information that indicates whether control information that provides an uplink grant to the UE is to include one resource indicator for SRS resources or two resource indicators for SRS resources. The control information manager 930 may be configured as or otherwise support a means for receiving first control information that schedules two or more repetitions of a first uplink communication and that indicates an association between the two or more repetitions of the first uplink communication with either a first set of SRS resources, a second set of SRS resources, or both. The uplink transmission parameter manager 935 may be configured as or otherwise support a means for determining a first set of uplink transmission parameters for a first set of repetitions of the first uplink communication and a second set of uplink transmission parameters for a second set of repetitions of the first uplink communication based on one or two resource indicators in the first control information and the indicated one or both of the first set of SRS resources or the second set of SRS resources associated with the two or more repetitions of the first uplink communication. The uplink communication manager 940 may be configured as or otherwise support a means for transmitting the first set of repetitions of the first uplink communication using the first set of uplink transmission parameters and the second set of repetitions of the first uplink communication using the second set of uplink transmission parameters.

In some examples, the first set of SRS resources are associated with the first set of repetitions of the first uplink communication and the second set of SRS resources are associated with the second set of repetitions of the first uplink communication, and where the first set of repetitions of the first uplink communication is transmitted to a first TRP and the second set of repetitions of the first uplink communication is transmitted to a second TRP. In some examples, the first set of repetitions of the first uplink communication and the second set of repetitions of the first uplink communication are codebook-based or non-codebook-based physical uplink shared channel transmissions.

In some examples, to support receiving the first control information, the control information manager 930 may be configured as or otherwise support a means for decoding a first resource indictor in the first control information that provides a first SRS resource of the first set of SRS resources. In some examples, to support receiving the first control information, the control information manager 930 may be configured as or otherwise support a means for decoding a second resource indicator in the first control information that provides a second SRS resource of the second set of SRS resources.

In some examples, the SRS configuration information indicates that the first control information is to include the two resource indicators for SRS resources, and the control information manager 930 may be configured as or otherwise support a means for identifying that the first control information indicates that a single SRS resource set is associated with the first uplink communication. In some examples, the SRS configuration information indicates that the first control information is to include the two resource indicators for SRS resources, and the control information manager 930 may be configured as or otherwise support a means for determining both the first set of uplink transmission parameters and the second set of uplink transmission parameters based on a first resource indicator in the first control information. In some examples, the SRS configuration information indicates that the first control information is to include the two resource indicators for SRS resources, and the control information manager 930 may be configured as or otherwise support a means for ignoring a second resource indicator in the first control information.

In some examples, the SRS configuration information indicates that the first control information is to include the two resource indicators for SRS resources. In some examples, the control information manager 930 may be configured as or otherwise support a means for identifying that the first control information indicates that two SRS resource sets are associated with the first uplink communication, the control information manager 930 may be configured as or otherwise support a means for determining the first set of uplink transmission parameters based on a first resource indicator of the two resource indicators in the first control information, and the control information manager 930 may be configured as or otherwise support a means for determining the second set of uplink transmission parameters based on a second resource indicator of the two resource indicators in the first control information.

In some examples, the SRS configuration information indicates that the first control information is to include a single resource indicator for SRS resources, and where both the first set of uplink transmission parameters and the second set of uplink transmission parameters are determined based on the single resource indicator in the first control information. In some examples, the SRI manager 945 may be configured as or otherwise support a means for identifying that the first control information indicates that a single SRS resource set is associated with the first uplink communication. In some examples, the SRI manager 945 may be configured as or otherwise support a means for determining both the first set of uplink transmission parameters and the second set of uplink transmission parameters based on the single resource indicator in the first control information and the single SRS resource set.

In some examples, the control information manager 930 may be configured as or otherwise support a means for identifying that the first control information indicates that two SRS resource sets are associated with the first uplink communication. In some examples, the control information manager 930 may be configured as or otherwise support a means for determining the first set of uplink transmission parameters based on the single resource indicator in the first control information and a first mapping between the single resource indicator and SRS resources of a first SRS resource set. In some examples, the control information manager 930 may be configured as or otherwise support a means for determining the second set of uplink transmission parameters based on the single resource indicator in the first control information and a second mapping between the single resource indicator and SRS resources of a second SRS resource set.

In some examples, the SRS configuration information separately configures two or more different control information formats to include the one resource indicator for SRS resources or the two resource indicators for SRS resources. In some examples, the first set of repetitions of the first uplink communication and the second set of repetitions of the first uplink communication are codebook-based physical uplink shared channel transmissions and one SRS resource within each set of SRS resources is indicated for each codebook-based resource indicator. In some examples, the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

In some examples, the first set of repetitions of the first uplink communication and the second set of repetitions of the first uplink communication are codebook-based physical uplink shared channel transmissions and the SRS configuration information indicates that the first control information is to include the two resource indicators for SRS resources, and where each of the two resource indicators are mapped to SRS resources within the associated set of SRS resources that have a same number of antenna ports. In some examples, the first set of repetitions of the first uplink communication and the second set of repetitions of the first uplink communication are codebook-based physical uplink shared channel transmissions and the SRS configuration information indicates that the first control information is to include the two resource indicators for SRS resources, and where an i-th configured SRS resource of a first SRS resource set has a same number of antenna ports as an i-th configured SRS resource of a second SRS resource set.

In some examples, the first set of repetitions of the first uplink communication and the second set of repetitions of the first uplink communication are non-codebook-based physical uplink shared channel transmissions and the SRS configuration information indicates that the first control information is to include the two resource indicators for SRS resources, and where a first quantity of indicated SRS resources within the first set of SRS resources is a same quantity as a second quantity of indicated SRS resources within the second set of SRS resources. In some examples, the SRS configuration information indicates that the first control information is to include a single resource indicator for SRS resources within the first set of SRS resources and the second set of SRS resources. In some examples, the first set of SRS resources and the second set of SRS resources have a same number of SRS resources, or a number of bits in the single resource indicator is determined based on a maximum number of SRS resources of the first set of SRS resources or the second set of SRS resources.

In some examples, to support receiving the first control information, the SRI manager 945 may be configured as or otherwise support a means for identifying a two-bit field within the first control information that indicates that the first uplink communication is to use the first set of SRS resources only, is to use the second set of SRS resources only, or is to use both the first set of SRS resources and the second set of SRS resources and determine which set of repetitions of the first uplink communication is to use the first set of SRS resources and that the other set of repetitions is to use the second set of SRS resources. In some examples, to support receiving the first control information, the SRI manager 945 may be configured as or otherwise support a means for identifying a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources. In some examples, the first bit value provides a predetermined indication that the first uplink communication is to use the first set of SRS resources. In some examples, the first bit value is configured by the SRS configuration information to indicate that the first uplink communication is to use the first set of SRS resources. In some examples, the first bit value indicates that a different information field in the first control information provides an indication that the first uplink communication is to use either the first set of SRS resources or the second set of SRS resources. In some examples, an indication that one of the first set of SRS resources or the second set of SRS resources is unused is provided by a reserved value of a resource indication of the associated set of SRS resources.

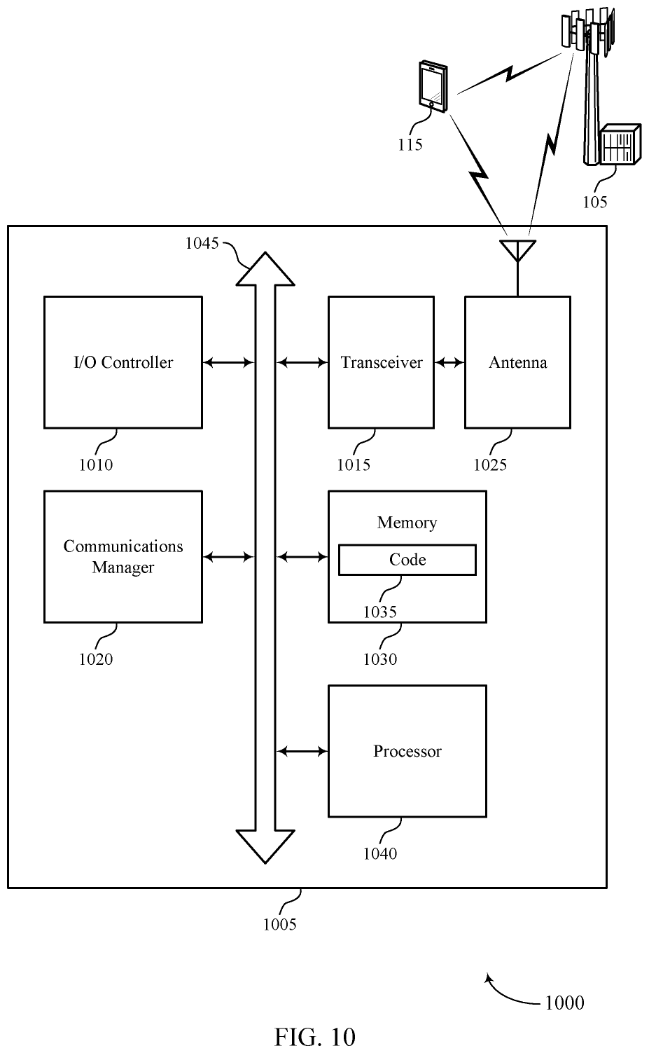

FIG. 10 shows a diagram of a system 1000 including a device 1005 that supports resource signaling techniques for multiple repetitions of uplink transmissions in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting resource signaling techniques for multiple repetitions of uplink transmissions). For example, the device 1005 or a component of the device 1005 may include a processor 1040 and memory 1030 coupled with the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving, from a base station, SRS configuration information that indicates whether control information that provides an uplink grant to the UE is to include one resource indicator for SRS resources or two resource indicators for SRS resources. The communications manager 1020 may be configured as or otherwise support a means for receiving first control information that schedules two or more repetitions of a first uplink communication and that indicates an association between the two or more repetitions of the first uplink communication with either a first set of SRS resources, a second set of SRS resources, or both. The communications manager 1020 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The communications manager 1020 may be configured as or otherwise support a means for transmitting the first set of repetitions of the first uplink communication using the first set of uplink transmission parameters and the second set of repetitions of the first uplink communication using the second set of uplink transmission parameters.

By including or configuring the communications manager 1020 in accordance with examples as described herein, the device 1005 may support techniques for transmitting multiple repetitions of an uplink communication to multiple different TRPs, such that the different repetitions may use transmission parameters that are suitable for the particular TRP associated with the repetition. Such techniques may allow for enhanced reliability of wireless communications, and thus provide more efficient utilization of communication resources, reduced power consumption (through reduced retransmissions), reduced latency (through reduced retransmission), and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of resource signaling techniques for multiple repetitions of uplink transmissions as described herein, or the processor 1040 and the memory 1030 may be otherwise configured to perform or support such operations.

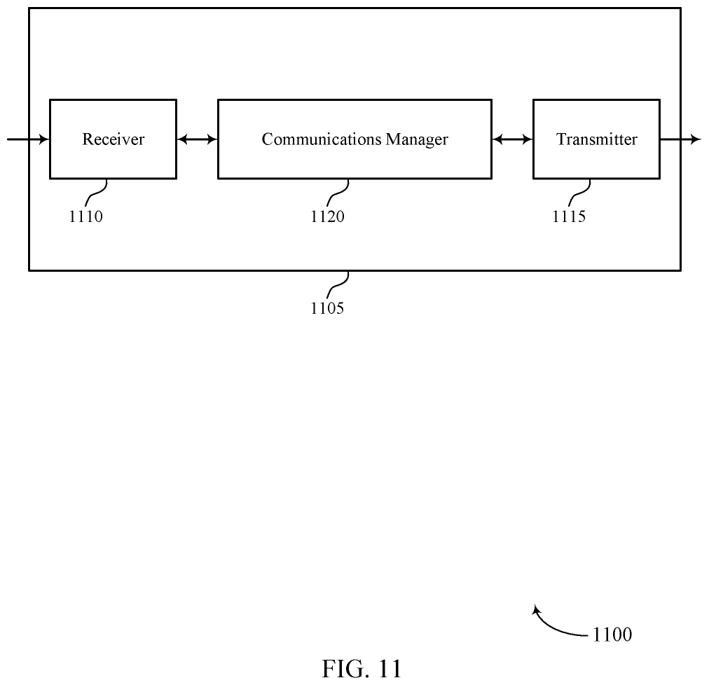

FIG. 11 shows a block diagram 1100 of a device 1105 that supports resource signaling techniques for multiple repetitions of uplink transmissions in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to resource signaling techniques for multiple repetitions of uplink transmissions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to resource signaling techniques for multiple repetitions of uplink transmissions). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of resource signaling techniques for multiple repetitions of uplink transmissions as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for transmitting, to a UE, SRS configuration information that indicates whether control information that provides an uplink grant to the UE is to include one resource indicator for SRS resources or two resource indicators for SRS resources. The communications manager 1120 may be configured as or otherwise support a means for transmitting first control information to the UE that schedules two or more repetitions of a first uplink communication and that indicates an association between the two or more repetitions of the first uplink communication with either a first set of SRS resources, a second set of SRS resources, or both. The communications manager 1120 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The communications manager 1120 may be configured as or otherwise support a means for receiving the first set of repetitions of the first uplink communication using the first set of uplink transmission parameters and the second set of repetitions of the first uplink communication using the second set of uplink transmission parameters.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for configuring UEs for transmission of multiple repetitions of an uplink communication to multiple different TRPs, such that the different repetitions may use transmission parameters that are suitable for the particular TRP associated with the repetition. Such techniques may allow for enhanced reliability of wireless communications, and thus provide more efficient utilization of communication resources, reduced power consumption (through reduced retransmissions), reduced latency (through reduced retransmission), and more efficient utilization of communication resources. Further, such techniques provide for flexibility in scheduling uplink communications with repetitions based on one or multiple SRS resource sets, which can enhance network efficiency through efficient scheduling of uplink communications in accordance with available network and wireless resources.

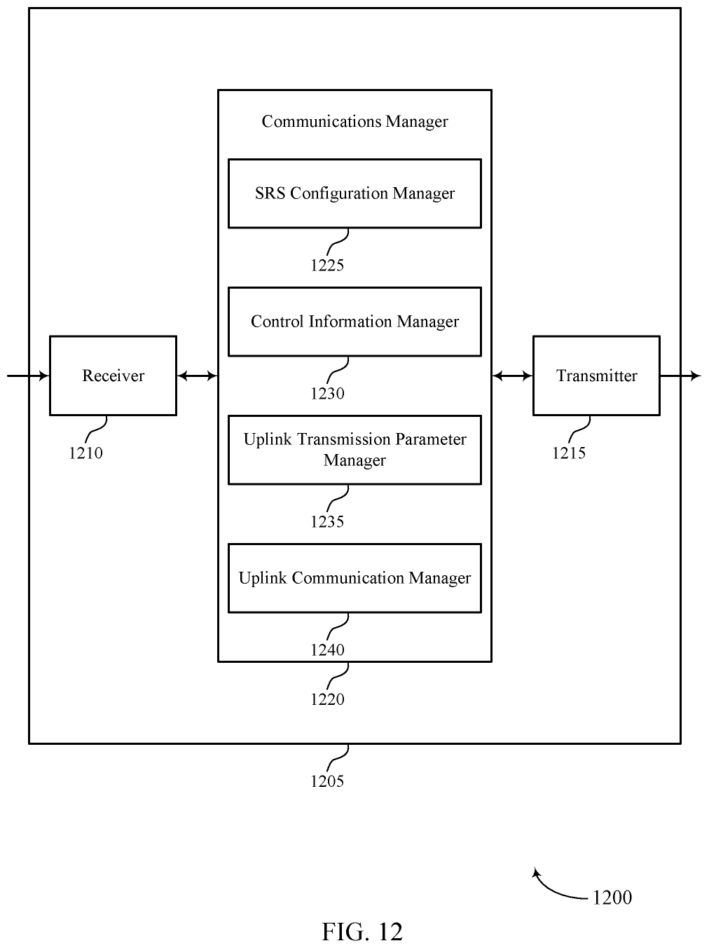

FIG. 12 shows a block diagram 1200 of a device 1205 that supports resource signaling techniques for multiple repetitions of uplink transmissions in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to resource signaling techniques for multiple repetitions of uplink transmissions). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to resource signaling techniques for multiple repetitions of uplink transmissions). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of resource signaling techniques for multiple repetitions of uplink transmissions as described herein. For example, the communications manager 1220 may include an SRS configuration manager 1225, a control information manager 1230, an uplink transmission parameter manager 1235, an uplink communication manager 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The SRS configuration manager 1225 may be configured as or otherwise support a means for transmitting, to a UE, SRS configuration information that indicates whether control information that provides an uplink grant to the UE is to include one resource indicator for SRS resources or two resource indicators for SRS resources. The control information manager 1230 may be configured as or otherwise support a means for transmitting first control information to the UE that schedules two or more repetitions of a first uplink communication and that indicates an association between the two or more repetitions of the first uplink communication with either a first set of SRS resources, a second set of SRS resources, or both. The uplink transmission parameter manager 1235 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The uplink communication manager 1240 may be configured as or otherwise support a means for receiving the first set of repetitions of the first uplink communication using the first set of uplink transmission parameters and the second set of repetitions of the first uplink communication using the second set of uplink transmission parameters.

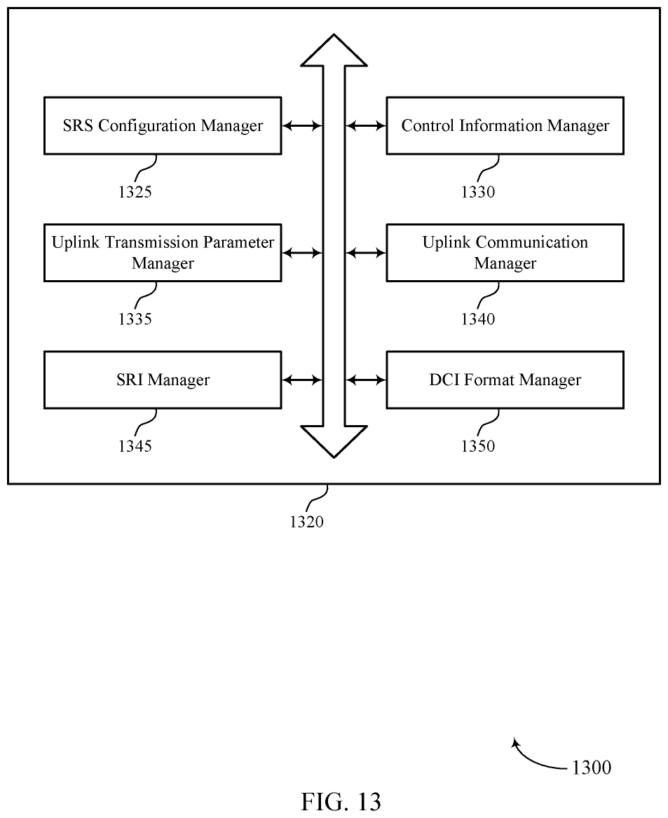

FIG. 13 shows a block diagram 1300 of a communications manager 1320 that supports resource signaling techniques for multiple repetitions of uplink transmissions in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of resource signaling techniques for multiple repetitions of uplink transmissions as described herein. For example, the communications manager 1320 may include an SRS configuration manager 1325, a control information manager 1330, an uplink transmission parameter manager 1335, an uplink communication manager 1340, an SRI manager 1345, a DCI format manager 1350, or any combination thereof. Each of these components may communicate, directly or indirectly, with one another (e.g., via one or more buses).

The communications manager 1320 may support wireless communication at a base station in accordance with examples as disclosed herein. The SRS configuration manager 1325 may be configured as or otherwise support a means for transmitting, to a UE, SRS configuration information that indicates whether control information that provides an uplink grant to the UE is to include one resource indicator for SRS resources or two resource indicators for SRS resources. The control information manager 1330 may be configured as or otherwise support a means for transmitting first control information to the UE that schedules two or more repetitions of a first uplink communication and that indicates an association between the two or more repetitions of the first uplink communication with either a first set of SRS resources, a second set of SRS resources, or both. The uplink transmission parameter manager 1335 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The uplink communication manager 1340 may be configured as or otherwise support a means for receiving the first set of repetitions of the first uplink communication using the first set of uplink transmission parameters and the second set of repetitions of the first uplink communication using the second set of uplink transmission parameters.

In some examples, the first set of SRS resources are associated with the first set of repetitions of the first uplink communication and the second set of SRS resources are associated with the second set of repetitions of the first uplink communication, and where the first set of repetitions of the first uplink communication is transmitted to a first TRP and the second set of repetitions of the first uplink communication is transmitted to a second TRP.

In some examples, the first set of repetitions of the first uplink communication and the second set of repetitions of the first uplink communication are codebook-based or non-codebook-based physical uplink shared channel transmissions. In some examples, to support transmitting the first control information, the control information manager 1330 may be configured as or otherwise support a means for transmitting a first resource indictor in the first control information that provides a first SRS resource of the first set of SRS resources. In some examples, to support transmitting the first control information, the control information manager 1330 may be configured as or otherwise support a means for transmitting a second resource indicator in the first control information that provides a second SRS resource of the second set of SRS resources.

In some examples, the SRS configuration information indicates that the first control information is to include the two resource indicators for SRS resources. In some examples, the first control information indicates that a single SRS resource set is associated with the first uplink communication. In some examples, both the first set of uplink transmission parameters and the second set of uplink transmission parameters based on a first resource indicator in the first control information irrespective of a value of a second resource indicator in the first control information.

In some examples, the SRS configuration information indicates that the first control information is to include the two resource indicators for SRS resources. In some examples, to the method, the control information manager 1330 may be configured as or otherwise support a means for transmitting an indication in the first control information that two SRS resource sets are associated with the first uplink communication and the control information manager 1330 may be configured as or otherwise support a means for where the first set of uplink transmission parameters being based on a first resource indicator of the two resource indicators in the first control information, and the second set of uplink transmission parameters are based on a second resource indicator of the two resource indicators in the first control information.

In some examples, the SRS configuration information indicates that the first control information is to include a single resource indicator for SRS resources, and where both the first set of uplink transmission parameters and the second set of uplink transmission parameters are determined based on the single resource indicator in the first control information. In some examples, the SRI manager 1345 may be configured as or otherwise support a means for transmitting, in the first control information, an indication that a single SRS resource set is associated with the first uplink communication, and where both the first set of uplink transmission parameters and the second set of uplink transmission parameters are based on the single resource indicator in the first control information and the single SRS resource set.

In some examples, the control information manager 1330 may be configured as or otherwise support a means for transmitting, in the first control information, an indication that two SRS resource sets are associated with the first uplink communication. In some examples, the control information manager 1330 may be configured as or otherwise support a means for the first set of uplink transmission parameters are based on the single resource indicator in the first control information and a first mapping between the single resource indicator and SRS resources of a first SRS resource set. In some examples, the control information manager 1330 may be configured as or otherwise support a means for the second set of uplink transmission parameters are based on the single resource indicator in the first control information and a second mapping between the single resource indicator and SRS resources of a second SRS resource set.

In some examples, the SRS configuration information separately configures two or more different control information formats to include the one resource indicator for SRS resources or the two resource indicators for SRS resources.

In some examples, the first set of repetitions of the first uplink communication and the second set of repetitions of the first uplink communication are codebook-based physical uplink shared channel transmissions and one SRS resource within each set of SRS resources is indicated for each codebook-based resource indicator. In some examples, the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

In some examples, the first set of repetitions of the first uplink communication and the second set of repetitions of the first uplink communication are codebook-based physical uplink shared channel transmissions and the SRS configuration information indicates that the first control information is to include the two resource indicators for SRS resources, and where each of the two resource indicators are mapped to SRS resources within the associated set of SRS resources that have a same number of antenna ports. In some examples, the first set of repetitions of the first uplink communication and the second set of repetitions of the first uplink communication are codebook-based physical uplink shared channel transmissions and the SRS configuration information indicates that the first control information is to include the two resource indicators for SRS resources, and where an i-th configured SRS resource of a first SRS resource set has a same number of antenna ports as an i-th configured SRS resource of a second SRS resource set.

In some examples, the first set of repetitions of the first uplink communication and the second set of repetitions of the first uplink communication are non-codebook-based physical uplink shared channel transmissions and the SRS configuration information indicates that the first control information is to include the two resource indicators for SRS resources, and where a first quantity of indicated SRS resources within the first set of SRS resources is a same quantity as a second quantity of indicated SRS resources within the second set of SRS resources. In some examples, the SRS configuration information indicates that the first control information is to include a single resource indicator for SRS resources within the first set of SRS resources and the second set of SRS resources. In some examples, the first set of SRS resources and the second set of SRS resources have a same number of SRS resources, or a number of bits in the single resource indicator is determined based on a maximum number of SRS resources of the first set of SRS resources or the second set of SRS resources.

In some examples, to support transmitting the first control information, the SRI manager 1345 may be configured as or otherwise support a means for transmitting a two-bit field within the first control information that indicates that the first uplink communication is to use the first set of SRS resources only, is to use the second set of SRS resources only, or that the UE is to use both the first set of SRS resources and the second set of SRS resources and determine which set of repetitions of the first uplink communication is to use the first set of SRS resources and that the other set of repetitions is to use the second set of SRS resources.

In some examples, to support transmitting the first control information, the SRI manager 1345 may be configured as or otherwise support a means for transmitting a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources.

In some examples, the first bit value provides a predetermined indication that the first uplink communication is to use the first set of SRS resources. In some examples, the first bit value is configured with the SRS configuration information to indicate that the first uplink communication is to use the first set of SRS resources. In some examples, the first bit value indicates that a different information field in the first control information provides an indication that the first uplink communication is to use either the first set of SRS resources or the second set of SRS resources. In some examples, an indication that one of the first set of SRS resources or the second set of SRS resources is unused is provided by a reserved value of a resource indication of the associated set of SRS resources.

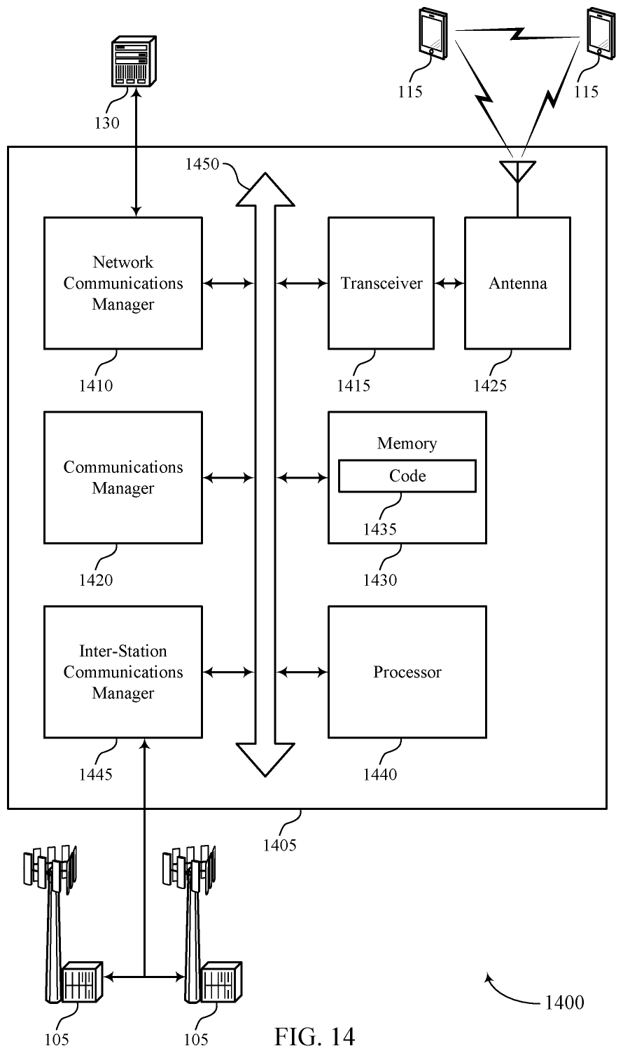

FIG. 14 shows a diagram of a system 1400 including a device 1405 that supports resource signaling techniques for multiple repetitions of uplink transmissions in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting resource signaling techniques for multiple repetitions of uplink transmissions). For example, the device 1405 or a component of the device 1405 may include a processor 1440 and memory 1430 coupled with the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for transmitting, to a UE, SRS configuration information that indicates whether control information that provides an uplink grant to the UE is to include one resource indicator for SRS resources or two resource indicators for SRS resources. The communications manager 1420 may be configured as or otherwise support a means for transmitting first control information to the UE that schedules two or more repetitions of a first uplink communication and that indicates an association between the two or more repetitions of the first uplink communication with either a first set of SRS resources, a second set of SRS resources, or both. The communications manager 1420 may be configured as or otherwise support a means for determining a first set of uplink transmission parameters for a first set of repetitions of the first uplink communication and a second set of uplink transmission parameters for a second set of repetitions of the first uplink communication based on the one or two resource indicators in the first control information and the indicated one or both of the first set of SRS resources or the second set of SRS resources associated with the two or more repetitions of the first uplink communication. The communications manager 1420 may be configured as or otherwise support a means for receiving the first set of repetitions of the first uplink communication using the first set of uplink transmission parameters and the second set of repetitions of the first uplink communication using the second set of uplink transmission parameters.

By including or configuring the communications manager 1420 in accordance with examples as described herein, the device 1405 may support techniques for configuring UEs for transmission of multiple repetitions of an uplink communication to multiple different TRPs, such that the different repetitions may use transmission parameters that are suitable for the particular TRP associated with the repetition. Such techniques may allow for enhanced reliability of wireless communications, and thus provide more efficient utilization of communication resources, reduced power consumption (through reduced retransmissions), reduced latency (through reduced retransmission), and more efficient utilization of communication resources. Further, such techniques provide for flexibility in scheduling uplink communications with repetitions based on one or multiple SRS resource sets, which can enhance network efficiency through efficient scheduling of uplink communications in accordance with available network and wireless resources.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of resource signaling techniques for multiple repetitions of uplink transmissions as described herein, or the processor 1440 and the memory 1430 may be otherwise configured to perform or support such operations.

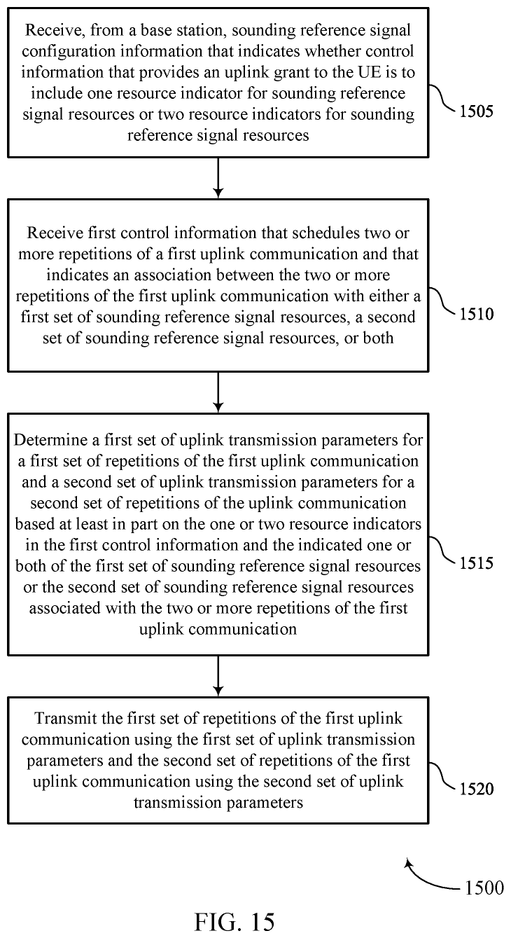

FIG. 15 shows a flowchart illustrating a method 1500 that supports resource signaling techniques for multiple repetitions of uplink transmissions in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, SRS configuration information that indicates whether control information that provides an uplink grant to the UE is to include one resource indicator for SRS resources or two resource indicators for SRS resources. The operations of 1505 may be performed in accordance with examples as disclosed herein. In some examples, aspects of the operations of 1505 may be performed by an SRS configuration manager 925 as described with reference to FIG. 9.

At 1510, the method may include receiving first control information that schedules two or more repetitions of a first uplink communication and that indicates an association between the two or more repetitions of the first uplink communication with either a first set of SRS resources, a second set of SRS resources, or both. The operations of 1510 may be performed in accordance with examples as disclosed herein. In some examples, aspects of the operations of 1510 may be performed by a control information manager 930 as described with reference to FIG. 9.

At 1515, the method may include determining a first set of uplink transmission parameters for a first set of repetitions of the first uplink communication and a second set of uplink transmission parameters for a second set of repetitions of the first uplink communication based on one or two resource indicators in the first control information and the indicated one or both of the first set of SRS resources or the second set of SRS resources associated with the two or more repetitions of the first uplink communication. The operations of 1515 may be performed in accordance with examples as disclosed herein. In some examples, aspects of the operations of 1515 may be performed by an uplink transmission parameter manager 935 as described with reference to FIG. 9.

At 1520, the method may include transmitting the first set of repetitions of the first uplink communication using the first set of uplink transmission parameters and the second set of repetitions of the first uplink communication using the second set of uplink transmission parameters. The operations of 1520 may be performed in accordance with examples as disclosed herein. In some examples, aspects of the operations of 1520 may be performed by an uplink communication manager 940 as described with reference to FIG. 9.

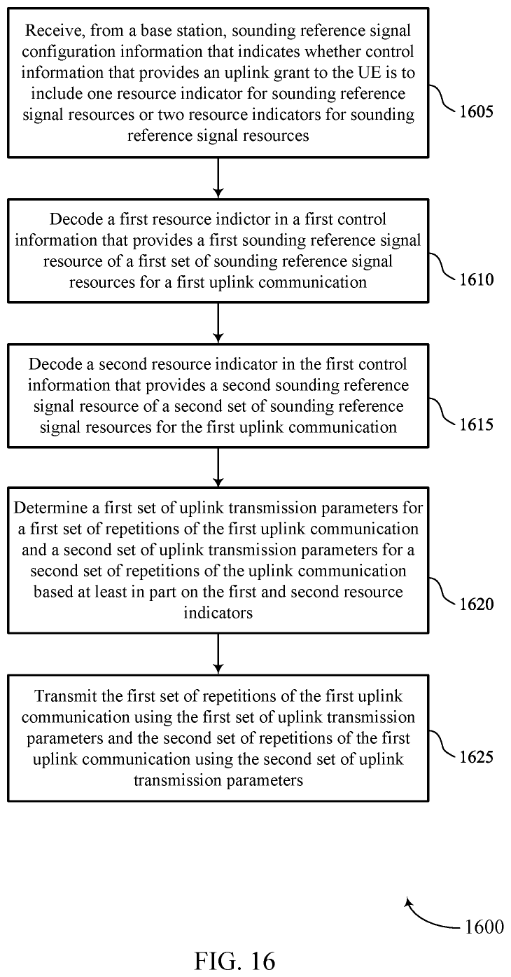

FIG. 16 shows a flowchart illustrating a method 1600 that supports resource signaling techniques for multiple repetitions of uplink transmissions in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, SRS configuration information that indicates whether control information that provides an uplink grant to the UE is to include one resource indicator for SRS resources or two resource indicators for SRS resources. The operations of 1605 may be performed in accordance with examples as disclosed herein. In some examples, aspects of the operations of 1605 may be performed by an SRS configuration manager 925 as described with reference to FIG. 9.

At 1610, the method may include decoding a first resource indictor in a first control information that provides a first SRS resource of a first set of SRS resources for a first uplink communication. The operations of 1610 may be performed in accordance with examples as disclosed herein. In some examples, aspects of the operations of 1610 may be performed by a control information manager 930 as described with reference to FIG. 9.

At 1615, the method may include decoding a second resource indicator in the first control information that provides a second SRS resource of a second set of SRS resources for the first uplink communication. The operations of 1615 may be performed in accordance with examples as disclosed herein. In some examples, aspects of the operations of 1615 may be performed by a control information manager 930 as described with reference to FIG. 9.

At 1620, the method may include determining a first set of uplink transmission parameters for a first set of repetitions of the first uplink communication and a second set of uplink transmission parameters for a second set of repetitions of the first uplink communication based at least in part on the first and second resource indicators. The operations of 1620 may be performed in accordance with examples as disclosed herein. In some examples, aspects of the operations of 1620 may be performed by an uplink transmission parameter manager 935 as described with reference to FIG. 9.

At 1625, the method may include transmitting the first set of repetitions of the first uplink communication using the first set of uplink transmission parameters and the second set of repetitions of the first uplink communication using the second set of uplink transmission parameters. The operations of 1625 may be performed in accordance with examples as disclosed herein. In some examples, aspects of the operations of 1625 may be performed by an uplink communication manager 940 as described with reference to FIG. 9.

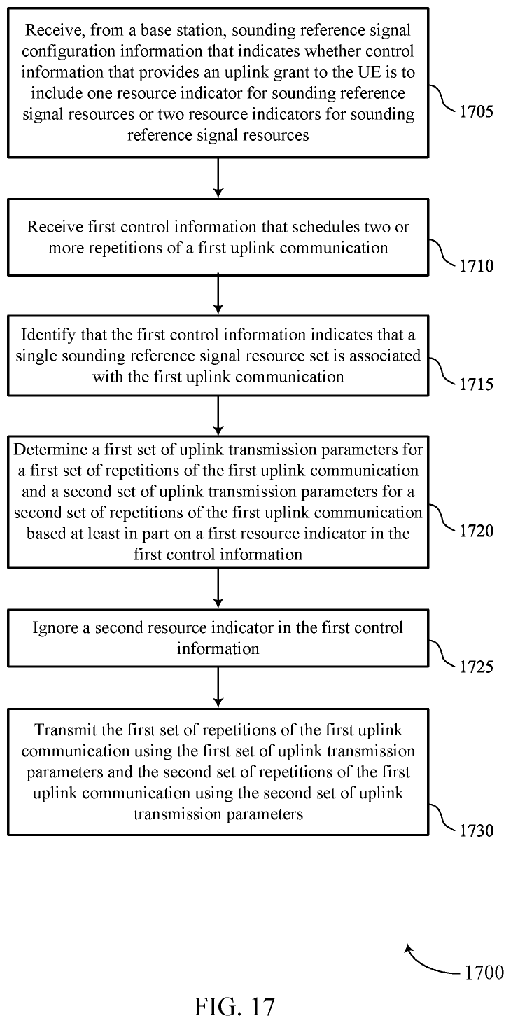

FIG. 17 shows a flowchart illustrating a method 1700 that supports resource signaling techniques for multiple repetitions of uplink transmissions in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, SRS configuration information that indicates whether control information that provides an uplink grant to the UE is to include one resource indicator for SRS resources or two resource indicators for SRS resources. The operations of 1705 may be performed in accordance with examples as disclosed herein. In some examples, aspects of the operations of 1705 may be performed by an SRS configuration manager 925 as described with reference to FIG. 9.

At 1710, the method may include receiving first control information that schedules two or more repetitions of a first uplink communication. The operations of 1710 may be performed in accordance with examples as disclosed herein. In some examples, aspects of the operations of 1710 may be performed by a control information manager 930 as described with reference to FIG. 9.

At 1715, the method may include identifying that the first control information indicates that a single SRS resource set is associated with the first uplink communication. The operations of 1715 may be performed in accordance with examples as disclosed herein. In some examples, aspects of the operations of 1715 may be performed by a control information manager 930 as described with reference to FIG. 9.

At 1720, the method may include determining a first set of uplink transmission parameters for a first set of repetitions of the first uplink communication and a second set of uplink transmission parameters for a second set of repetitions of the first uplink communication based on a first resource indicator in the first control information. The operations of 1720 may be performed in accordance with examples as disclosed herein. In some examples, aspects of the operations of 1720 may be performed by a control information manager 930 as described with reference to FIG. 9.

At 1725, the method may include ignoring a second resource indicator in the first control information. The operations of 1725 may be performed in accordance with examples as disclosed herein. In some examples, aspects of the operations of 1725 may be performed by a control information manager 930 as described with reference to FIG. 9.

At 1730, the method may include transmitting the first set of repetitions of the first uplink communication using the first set of uplink transmission parameters and the second set of repetitions of the first uplink communication using the second set of uplink transmission parameters. The operations of 1730 may be performed in accordance with examples as disclosed herein. In some examples, aspects of the operations of 1730 may be performed by an uplink communication manager 940 as described with reference to FIG. 9.

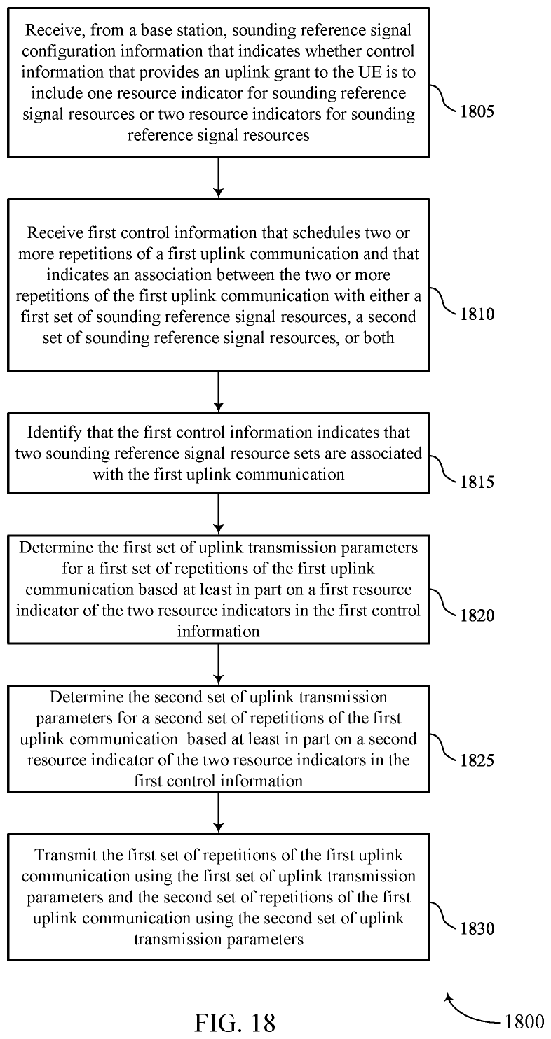

FIG. 18 shows a flowchart illustrating a method 1800 that supports resource signaling techniques for multiple repetitions of uplink transmissions in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, SRS configuration information that indicates whether control information that provides an uplink grant to the UE is to include one resource indicator for SRS resources or two resource indicators for SRS resources. The operations of 1805 may be performed in accordance with examples as disclosed herein. In some examples, aspects of the operations of 1805 may be performed by an SRS configuration manager 925 as described with reference to FIG. 9.

At 1810, the method may include receiving first control information that schedules two or more repetitions of a first uplink communication and that indicates an association between the two or more repetitions of the first uplink communication with either a first set of SRS resources, a second set of SRS resources, or both. The operations of 1810 may be performed in accordance with examples as disclosed herein. In some examples, aspects of the operations of 1810 may be performed by a control information manager 930 as described with reference to FIG. 9.

At 1815, the method may include identifying that the first control information indicates that two SRS resource sets are associated with the first uplink communication. The operations of 1815 may be performed in accordance with examples as disclosed herein. In some examples, aspects of the operations of 1815 may be performed by a control information manager 930 as described with reference to FIG. 9.

At 1820, the method may include determining the second set of uplink transmission parameters for a second set of repetitions of the first uplink communication based at least in part on a second resource indicator of the two resource indicators in the first control information. The operations of 1820 may be performed in accordance with examples as disclosed herein. In some examples, aspects of the operations of 1820 may be performed by a control information manager 930 as described with reference to FIG. 9.

At 1825, the method may include determining the first set of uplink transmission parameters for a first set of repetitions of the first uplink communication based at least in part on a first resource indicator of the two resource indicators in the first control information. The operations of 1825 may be performed in accordance with examples as disclosed herein. In some examples, aspects of the operations of 1825 may be performed by a control information manager 930 as described with reference to FIG. 9.

At 1830, the method may include transmitting the first set of repetitions of the first uplink communication using the first set of uplink transmission parameters and the second set of repetitions of the first uplink communication using the second set of uplink transmission parameters. The operations of 1830 may be performed in accordance with examples as disclosed herein. In some examples, aspects of the operations of 1830 may be performed by an uplink communication manager 940 as described with reference to FIG. 9.

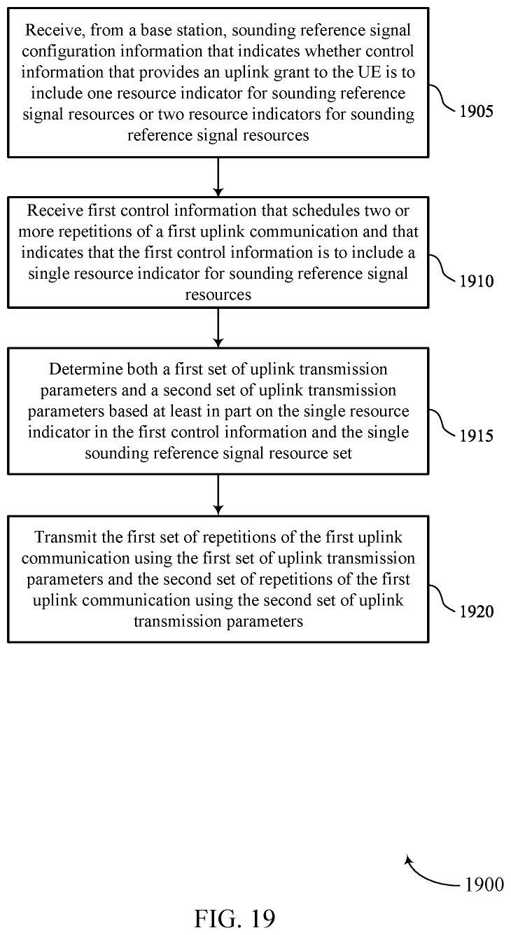

FIG. 19 shows a flowchart illustrating a method 1900 that supports resource signaling techniques for multiple repetitions of uplink transmissions in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, SRS configuration information that indicates whether control information that provides an uplink grant to the UE is to include one resource indicator for SRS resources or two resource indicators for SRS resources. The operations of 1905 may be performed in accordance with examples as disclosed herein. In some examples, aspects of the operations of 1905 may be performed by an SRS configuration manager 925 as described with reference to FIG. 9.

At 1910, the method may include receiving first control information that schedules two or more repetitions of a first uplink communication and that indicates that the first control information is to include a single resource indicator for SRS resources. The operations of 1910 may be performed in accordance with examples as disclosed herein. In some examples, aspects of the operations of 1910 may be performed by a control information manager 930 as described with reference to FIG. 9.

At 1915, the method may include determining both a first set of uplink transmission parameters and a second set of uplink transmission parameters based on the single resource indicator in the first control information and the single SRS resource set. The operations of 1915 may be performed in accordance with examples as disclosed herein. In some examples, aspects of the operations of 1915 may be performed by an uplink transmission parameter manager 935 as described with reference to FIG. 9.

At 1920, the method may include transmitting the first set of repetitions of the first uplink communication using the first set of uplink transmission parameters and the second set of repetitions of the first uplink communication using the second set of uplink transmission parameters. The operations of 1920 may be performed in accordance with examples as disclosed herein. In some examples, aspects of the operations of 1920 may be performed by an uplink communication manager 940 as described with reference to FIG. 9.

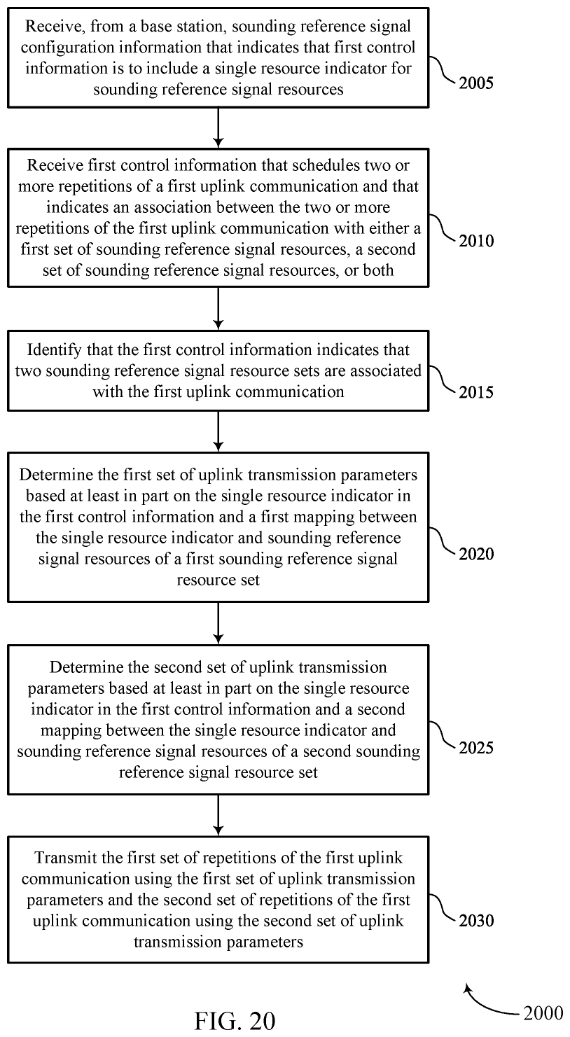

FIG. 20 shows a flowchart illustrating a method 2000 that supports resource signaling techniques for multiple repetitions of uplink transmissions in accordance with aspects of the present disclosure. The operations of the method 2000 may be implemented by a UE or its components as described herein. For example, the operations of the method 2000 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 2005, the method may include receiving, from a base station, SRS configuration information that indicates that first control information is to include a single resource indicator for SRS resources. The operations of 2005 may be performed in accordance with examples as disclosed herein. In some examples, aspects of the operations of 2005 may be performed by an SRS configuration manager 925 as described with reference to FIG. 9.

At 2010, the method may include receiving first control information that schedules two or more repetitions of a first uplink communication and that indicates an association between the two or more repetitions of the first uplink communication with either a first set of SRS resources, a second set of SRS resources, or both. The operations of 2010 may be performed in accordance with examples as disclosed herein. In some examples, aspects of the operations of 2010 may be performed by a control information manager 930 as described with reference to FIG. 9.

At 2015, the method may include identifying that the first control information indicates that two SRS resource sets are associated with the first uplink communication. The operations of 2015 may be performed in accordance with examples as disclosed herein. In some examples, aspects of the operations of 2015 may be performed by an SRI manager 945 as described with reference to FIG. 9.

At 2020, the method may include determining the first set of uplink transmission parameters based on the single resource indicator in the first control information and a first mapping between the single resource indicator and SRS resources of a first SRS resource set. The operations of 2020 may be performed in accordance with examples as disclosed herein. In some examples, aspects of the operations of 2020 may be performed by a control information manager 930 as described with reference to FIG. 9.

At 2030, the method may include determining the second set of uplink transmission parameters based on the single resource indicator in the first control information and a second mapping between the single resource indicator and SRS resources of a second SRS resource set. The operations of 2030 may be performed in accordance with examples as disclosed herein. In some examples, aspects of the operations of 2030 may be performed by a control information manager 930 as described with reference to FIG. 9.

At 2030, the method may include transmitting the first set of repetitions of the first uplink communication using the first set of uplink transmission parameters and the second set of repetitions of the first uplink communication using the second set of uplink transmission parameters. The operations of 2030 may be performed in accordance with examples as disclosed herein. In some examples, aspects of the operations of 2030 may be performed by an uplink communication manager 940 as described with reference to FIG. 9.

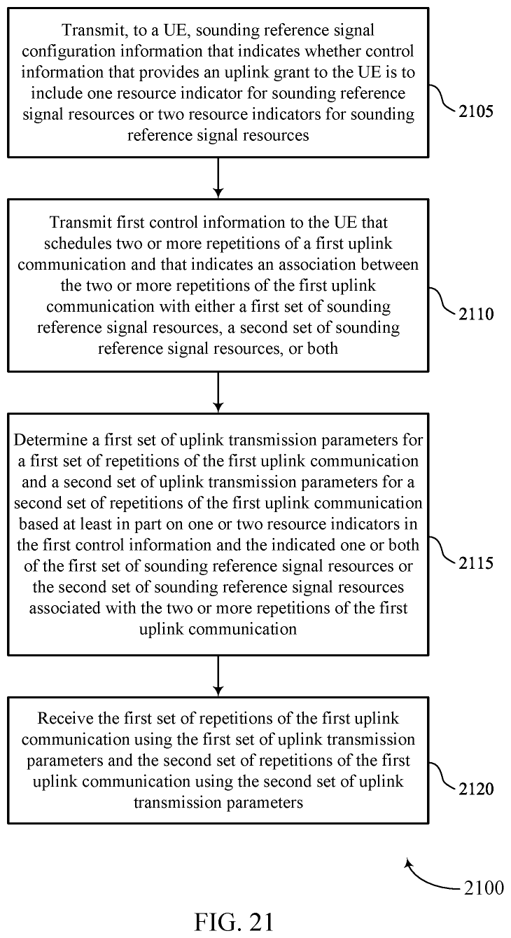

FIG. 21 shows a flowchart illustrating a method 2100 that supports resource signaling techniques for multiple repetitions of uplink transmissions in accordance with aspects of the present disclosure. The operations of the method 2100 may be implemented by a base station or its components as described herein. For example, the operations of the method 2100 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, SRS configuration information that indicates whether control information that provides an uplink grant to the UE is to include one resource indicator for SRS resources or two resource indicators for SRS resources. The operations of 2105 may be performed in accordance with examples as disclosed herein. In some examples, aspects of the operations of 2105 may be performed by an SRS configuration manager 1325 as described with reference to FIG. 13.

At 2110, the method may include transmitting first control information to the UE that schedules two or more repetitions of a first uplink communication and that indicates an association between the two or more repetitions of the first uplink communication with either a first set of SRS resources, a second set of SRS resources, or both. The operations of 2110 may be performed in accordance with examples as disclosed herein. In some examples, aspects of the operations of 2110 may be performed by a control information manager 1330 as described with reference to FIG. 13.

At 2115, the method may include determining a first set of uplink transmission parameters for a first set of repetitions of the first uplink communication and a second set of uplink transmission parameters for a second set of repetitions of the first uplink communication based on one or two resource indicators in the first control information and the indicated one or both of the first set of SRS resources or the second set of SRS resources associated with the two or more repetitions of the first uplink communication. The operations of 2115 may be performed in accordance with examples as disclosed herein. In some examples, aspects of the operations of 2115 may be performed by an uplink transmission parameter manager 1335 as described with reference to FIG. 13.

At 2120, the method may include receiving the first set of repetitions of the first uplink communication using the first set of uplink transmission parameters and the second set of repetitions of the first uplink communication using the second set of uplink transmission parameters. The operations of 2120 may be performed in accordance with examples as disclosed herein. In some examples, aspects of the operations of 2120 may be performed by an uplink communication manager 1340 as described with reference to FIG. 13.

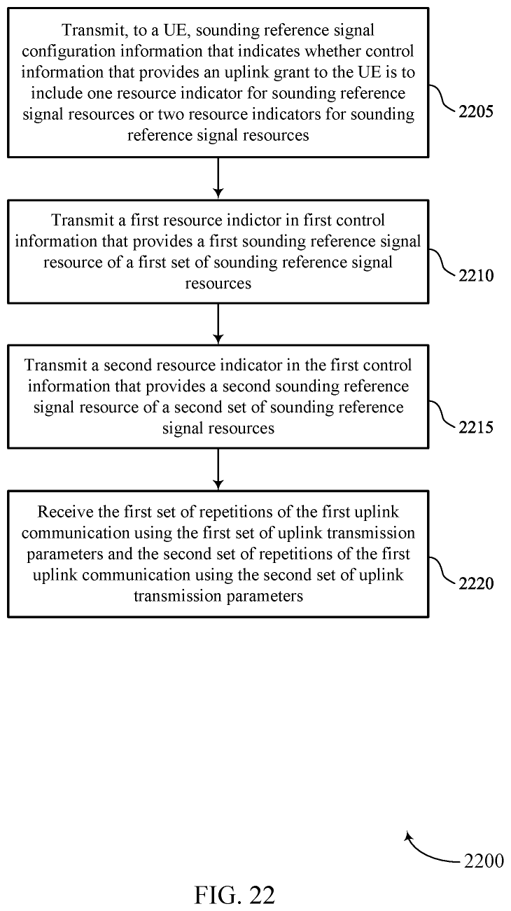

FIG. 22 shows a flowchart illustrating a method 2200 that supports resource signaling techniques for multiple repetitions of uplink transmissions in accordance with aspects of the present disclosure. The operations of the method 2200 may be implemented by a base station or its components as described herein. For example, the operations of the method 2200 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2205, the method may include transmitting, to a UE, SRS configuration information that indicates whether control information that provides an uplink grant to the UE is to include one resource indicator for SRS resources or two resource indicators for SRS resources. The operations of 2205 may be performed in accordance with examples as disclosed herein. In some examples, aspects of the operations of 2205 may be performed by an SRS configuration manager 1325 as described with reference to FIG. 13.

At 2210, the method may include transmitting a first resource indictor in first control information that provides a first SRS resource of a first set of SRS resources. The operations of 2215 may be performed in accordance with examples as disclosed herein. In some examples, aspects of the operations of 2215 may be performed by a control information manager 1330 as described with reference to FIG. 13.

At 2215, the method may include transmitting a second resource indicator in the first control information that provides a second SRS resource of a second set of SRS resources. The operations of 2215 may be performed in accordance with examples as disclosed herein. In some examples, aspects of the operations of 2215 may be performed by a control information manager 1330 as described with reference to FIG. 13.

At 2220, the method may include receiving the first set of repetitions of the first uplink communication using the first set of uplink transmission parameters and the second set of repetitions of the first uplink communication using the second set of uplink transmission parameters. The operations of 2220 may be performed in accordance with examples as disclosed herein. In some examples, aspects of the operations of 2220 may be performed by an uplink communication manager 1340 as described with reference to FIG. 13.

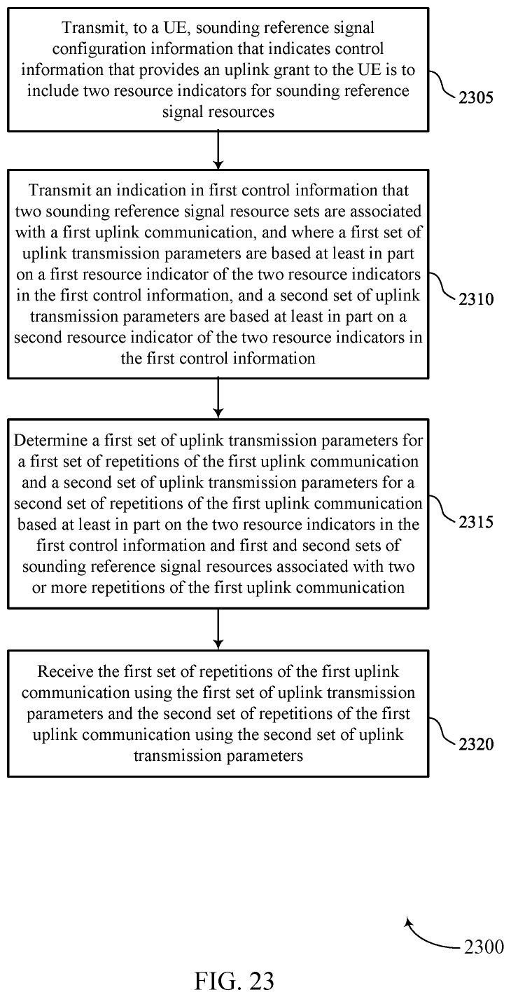

FIG. 23 shows a flowchart illustrating a method 2300 that supports resource signaling techniques for multiple repetitions of uplink transmissions in accordance with aspects of the present disclosure. The operations of the method 2300 may be implemented by a base station or its components as described herein. For example, the operations of the method 2300 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2305, the method may include transmitting, to a UE, SRS configuration information that indicates control information that provides an uplink grant to the UE is to include two resource indicators for SRS resources. The operations of 2305 may be performed in accordance with examples as disclosed herein. In some examples, aspects of the operations of 2305 may be performed by an SRS configuration manager 1325 as described with reference to FIG. 13.

At 2310, the method may include transmitting an indication in first control information that two SRS resource sets are associated with a first uplink communication and where a first set of uplink transmission parameters are based on a first resource indicator of the two resource indicators in the first control information, and a second set of uplink transmission parameters are based on a second resource indicator of the two resource indicators in the first control information. The operations of 2310 may be performed in accordance with examples as disclosed herein. In some examples, aspects of the operations of 2310 may be performed by a control information manager 1330 as described with reference to FIG. 13.

At 2315, the method may include determining a first set of uplink transmission parameters for a first set of repetitions of the first uplink communication and a second set of uplink transmission parameters for a second set of repetitions of the first uplink communication based on the two resource indicators in the first control information and first and second sets of SRS resources associated with two or more repetitions of the first uplink communication. The operations of 2315 may be performed in accordance with examples as disclosed herein. In some examples, aspects of the operations of 2315 may be performed by an uplink transmission parameter manager 1335 as described with reference to FIG. 13.

At 2320, the method may include receiving the first set of repetitions of the first uplink communication using the first set of uplink transmission parameters and the second set of repetitions of the first uplink communication using the second set of uplink transmission parameters. The operations of 2320 may be performed in accordance with examples as disclosed herein. In some examples, aspects of the operations of 2320 may be performed by an uplink communication manager 1340 as described with reference to FIG. 13.

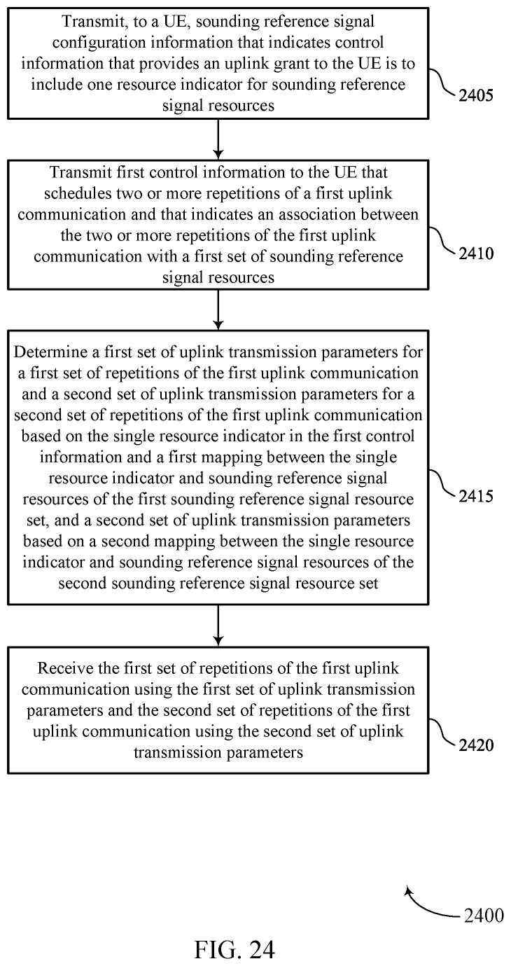

FIG. 24 shows a flowchart illustrating a method 2400 that supports resource signaling techniques for multiple repetitions of uplink transmissions in accordance with aspects of the present disclosure. The operations of the method 2400 may be implemented by a base station or its components as described herein. For example, the operations of the method 2400 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2405, the method may include transmitting, to a UE, SRS configuration information that indicates control information that provides an uplink grant to the UE is to include one resource indicator for SRS resources. The operations of 2405 may be performed in accordance with examples as disclosed herein. In some examples, aspects of the operations of 2405 may be performed by an SRS configuration manager 1325 as described with reference to FIG. 13.

At 2410, the method may include transmitting first control information to the UE that schedules two or more repetitions of a first uplink communication and that indicates an association between the two or more repetitions of the first uplink communication with a first set of SRS resources. The operations of 2410 may be performed in accordance with examples as disclosed herein. In some examples, aspects of the operations of 2410 may be performed by a control information manager 1330 as described with reference to FIG. 13.

At 2415, the method may include determining a first set of uplink transmission parameters for a first set of repetitions of the first uplink communication and a second set of uplink transmission parameters for a second set of repetitions of the first uplink communication based on the single resource indicator in the first control information and a first mapping between the single resource indicator and SRS resources of the first SRS resource set, and a second set of uplink transmission parameters based on a second mapping between the single resource indicator and SRS resources of the second SRS resource set. The operations of 2415 may be performed in accordance with examples as disclosed herein. In some examples, aspects of the operations of 2415 may be performed by an uplink transmission parameter manager 1335 as described with reference to FIG. 13.

At 2420, the method may include receiving the first set of repetitions of the first uplink communication using the first set of uplink transmission parameters and the second set of repetitions of the first uplink communication using the second set of uplink transmission parameters. The operations of 2420 may be performed in accordance with examples as disclosed herein. In some examples, aspects of the operations of 2420 may be performed by an uplink communication manager 1340 as described with reference to FIG. 13.

The following provides an overview of aspects of the present disclosure:

Aspect 1: A method for wireless communication at a UE, comprising: receiving, from a base station, SRS configuration information that indicates whether control information that provides an uplink grant to the UE is to include one resource indicator for SRS resources or two resource indicators for SRS resources; receiving first control information that schedules two or more repetitions of a first uplink communication and that indicates an association between the two or more repetitions of the first uplink communication with either a first set of SRS resources, a second set of SRS resources, or both; determining a first set of uplink transmission parameters for a first set of repetitions of the first uplink communication and a second set of uplink transmission parameters for a second set of repetitions of the first uplink communication based at least in part on the one or two resource indicators in the first control information and the indicated one or both of the first set of SRS resources or the second set of SRS resources associated with the two or more repetitions of the first uplink communication; and transmitting the first set of repetitions of the first uplink communication using the first set of uplink transmission parameters and the second set of repetitions of the first uplink communication using the second set of uplink transmission parameters.

Aspect 2: The method of aspect 1, wherein the first set of SRS resources are associated with the first set of repetitions of the first uplink communication and the second set of SRS resources are associated with the second set of repetitions of the first uplink communication, and wherein the first set of repetitions of the first uplink communication is transmitted to a first TRP and the second set of repetitions of the first uplink communication is transmitted to a second TRP.

Aspect 3: The method of any of aspects 1 through 2, wherein the first set of repetitions of the first uplink communication and the second set of repetitions of the first uplink communication are codebook-based or non-codebook-based physical uplink shared channel transmissions.

Aspect 4: The method of any of aspects 1 through 3, wherein the receiving the first control information further comprises: decoding a first resource indictor in the first control information that provides a first SRS resource of the first set of SRS resources; and decoding a second resource indicator in the first control information that provides a second SRS resource of the second set of SRS resources.

Aspect 5: The method of any of aspects 1 through 4, wherein the SRS configuration information indicates that the first control information is to include the two resource indicators for SRS resources, and wherein the method further comprises: identifying that the first control information indicates that a single SRS resource set is associated with the first uplink communication; determining both the first set of uplink transmission parameters and the second set of uplink transmission parameters based at least in part on a first resource indicator in the first control information; and ignoring a second resource indicator in the first control information.

Aspect 6: The method of any of aspects 1 through 5, wherein the SRS configuration information indicates that the first control information is to include the two resource indicators for SRS resources, and wherein the method further comprises: identifying that the first control information indicates that two SRS resource sets are associated with the first uplink communication; determining the first set of uplink transmission parameters based at least in part on a first resource indicator of the two resource indicators in the first control information; and determining the second set of uplink transmission parameters based at least in part on a second resource indicator of the two resource indicators in the first control information.

Aspect 7: The method of any of aspects 1 through 6, wherein the SRS configuration information indicates that the first control information is to include a single resource indicator for SRS resources, and wherein both the first set of uplink transmission parameters and the second set of uplink transmission parameters are determined based at least in part on the single resource indicator in the first control information.

Aspect 8: The method of aspect 7, further comprising: identifying that the first control information indicates that a single SRS resource set is associated with the first uplink communication; and determining both the first set of uplink transmission parameters and the second set of uplink transmission parameters based at least in part on the single resource indicator in the first control information and the single SRS resource set.

Aspect 9: The method of any of aspects 7 through 8, further comprising: identifying that the first control information indicates that two SRS resource sets are associated with the first uplink communication; determining the first set of uplink transmission parameters based at least in part on the single resource indicator in the first control information and a first mapping between the single resource indicator and SRS resources of a first SRS resource set; and determining the second set of uplink transmission parameters based at least in part on the single resource indicator in the first control information and a second mapping between the single resource indicator and SRS resources of a second SRS resource set.

Aspect 10: The method of any of aspects 1 through 9, wherein the SRS configuration information separately configures two or more different control information formats to include the one resource indicator for SRS resources or the two resource indicators for SRS resources.

Aspect 11: The method of any of aspects 1 through 10, wherein the first set of repetitions of the first uplink communication and the second set of repetitions of the first uplink communication are codebook-based physical uplink shared channel transmissions and one SRS resource within each set of SRS resources is indicated for each codebook-based resource indicator, or the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

Aspect 12: The method of any of aspects 1 through 11, wherein the first set of repetitions of the first uplink communication and the second set of repetitions of the first uplink communication are codebook-based physical uplink shared channel transmissions and the SRS configuration information indicates that the first control information is to include the two resource indicators for SRS resources, and wherein each of the two resource indicators are mapped to SRS resources within the associated set of SRS resources that have a same number of antenna ports.

Aspect 13: The method of any of aspects 1 through 12, wherein the first set of repetitions of the first uplink communication and the second set of repetitions of the first uplink communication are codebook-based physical uplink shared channel transmissions and the SRS configuration information indicates that the first control information is to include the two resource indicators for SRS resources, and wherein an i-th configured SRS resource of a first SRS resource set has a same number of antenna ports as an i-th configured SRS resource of a second SRS resource set.

Aspect 14: The method of any of aspects 1 through 13, wherein the first set of repetitions of the first uplink communication and the second set of repetitions of the first uplink communication are non-codebook-based physical uplink shared channel transmissions and the SRS configuration information indicates that the first control information is to include the two resource indicators for SRS resources, and wherein a first quantity of indicated SRS resources within the first set of SRS resources is a same quantity as a second quantity of indicated SRS resources within the second set of SRS resources.

Aspect 15: The method of any of aspects 1 through 14, wherein the SRS configuration information indicates that the first control information is to include a single resource indicator for SRS resources within the first set of SRS resources and the second set of SRS resources, and the first set of SRS resources and the second set of SRS resources have a same number of SRS resources, or a number of bits in the single resource indicator is determined based at least in part on a maximum number of SRS resources of the first set of SRS resources or the second set of SRS resources.

Aspect 16: The method of any of aspects 1 through 15, wherein the receiving the first control information further comprises: identifying a two-bit field within the first control information that indicates that the first uplink communication is to use the first set of SRS resources only, is to use the second set of SRS resources only, or is to use both the first set of SRS resources and the second set of SRS resources and determine which set of repetitions of the first uplink communication is to use the first set of SRS resources and that the other set of repetitions is to use the second set of SRS resources.

Aspect 17: The method of any of aspects 1 through 16, wherein the receiving the first control information further comprises: identifying a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources.

Aspect 18: The method of aspect 17, wherein the first bit value provides a predetermined indication that the first uplink communication is to use the first set of SRS resources, the first bit value is configured by the SRS configuration information to indicate that the first uplink communication is to use the first set of SRS resources, or the first bit value indicates that a different information field in the first control information provides an indication that the first uplink communication is to use either the first set of SRS resources or the second set of SRS resources.

Aspect 19: The method of any of aspects 1 through 18, wherein an indication that one of the first set of SRS resources or the second set of SRS resources is unused is provided by a reserved value of a resource indication of the associated set of SRS resources.

Aspect 20: A method for wireless communication at a base station, comprising: transmitting, to a UE, SRS configuration information that indicates whether control information that provides an uplink grant to the UE is to include one resource indicator for SRS resources or two resource indicators for SRS resources; transmitting first control information to the UE that schedules two or more repetitions of a first uplink communication and that indicates an association between the two or more repetitions of the first uplink communication with either a first set of SRS resources, a second set of SRS resources, or both; determining a first set of uplink transmission parameters for a first set of repetitions of the first uplink communication and a second set of uplink transmission parameters for a second set of repetitions of the first uplink communication based at least in part on the one or two resource indicators in the first control information and the indicated one or both of the first set of SRS resources or the second set of SRS resources associated with the two or more repetitions of the first uplink communication; and receiving the first set of repetitions of the first uplink communication using the first set of uplink transmission parameters and the second set of repetitions of the first uplink communication using the second set of uplink transmission parameters.

Aspect 21: The method of aspect 20, wherein the first set of SRS resources are associated with the first set of repetitions of the first uplink communication and the second set of SRS resources are associated with the second set of repetitions of the first uplink communication, and wherein the first set of repetitions of the first uplink communication is transmitted to a first TRP and the second set of repetitions of the first uplink communication is transmitted to a second TRP.

Aspect 22: The method of any of aspects 20 through 21, wherein the first set of repetitions of the first uplink communication and the second set of repetitions of the first uplink communication are codebook-based or non-codebook-based physical uplink shared channel transmissions.

Aspect 23: The method of any of aspects 20 through 22, wherein the transmitting the first control information further comprises: transmitting a first resource indictor in the first control information that provides a first SRS resource of the first set of SRS resources; and transmitting a second resource indicator in the first control information that provides a second SRS resource of the second set of SRS resources.

Aspect 24: The method of any of aspects 20 through 23, wherein the SRS configuration information indicates that the first control information is to include the two resource indicators for SRS resources, the first control information indicates that a single SRS resource set is associated with the first uplink communication, and both the first set of uplink transmission parameters and the second set of uplink transmission parameters based at least in part on a first resource indicator in the first control information irrespective of a value of a second resource indicator in the first control information.

Aspect 25: The method of any of aspects 20 through 24, wherein the SRS configuration information indicates that the first control information is to include the two resource indicators for SRS resources, and wherein the method further comprises: transmitting an indication in the first control information that two SRS resource sets are associated with the first uplink communication, and wherein the first set of uplink transmission parameters are based at least in part on a first resource indicator of the two resource indicators in the first control information, and the second set of uplink transmission parameters are based at least in part on a second resource indicator of the two resource indicators in the first control information.

Aspect 26: The method of any of aspects 20 through 25, wherein the SRS configuration information indicates that the first control information is to include a single resource indicator for SRS resources, and wherein both the first set of uplink transmission parameters and the second set of uplink transmission parameters are determined based at least in part on the single resource indicator in the first control information.

Aspect 27: The method of aspect 26, further comprising: transmitting, in the first control information, an indication that a single SRS resource set is associated with the first uplink communication, and wherein both the first set of uplink transmission parameters and the second set of uplink transmission parameters are based at least in part on the single resource indicator in the first control information and the single SRS resource set.

Aspect 28: The method of any of aspects 26 through 27, further comprising: transmitting, in the first control information, an indication that two SRS resource sets are associated with the first uplink communication, and wherein the first set of uplink transmission parameters are based at least in part on the single resource indicator in the first control information and a first mapping between the single resource indicator and SRS resources of a first SRS resource set; and the second set of uplink transmission parameters are based at least in part on the single resource indicator in the first control information and a second mapping between the single resource indicator and SRS resources of a second SRS resource set.

Aspect 29: The method of any of aspects 20 through 28, wherein the SRS configuration information separately configures two or more different control information formats to include the one resource indicator for SRS resources or the two resource indicators for SRS resources.

Aspect 30: The method of any of aspects 20 through 29, wherein the first set of repetitions of the first uplink communication and the second set of repetitions of the first uplink communication are codebook-based physical uplink shared channel transmissions and one SRS resource within each set of SRS resources is indicated for each codebook-based resource indicator, or the first set of repetitions of the first uplink communication and the second set of repetitions of the first uplink communication are non-codebook-based physical uplink shared channel transmissions and one or more SRS resources within each set of SRS resources are indicated for each non-codebook-based resource indicator.

Aspect 31: The method of any of aspects 20 through 30, wherein the first set of repetitions of the first uplink communication and the second set of repetitions of the first uplink communication are codebook-based physical uplink shared channel transmissions and the SRS configuration information indicates that the first control information is to include the two resource indicators for SRS resources, and wherein each of the two resource indicators are mapped to SRS resources within the associated set of SRS resources that have a same number of antenna ports.

Aspect 32: The method of any of aspects 20 through 31, wherein the first set of repetitions of the first uplink communication and the second set of repetitions of the first uplink communication are codebook-based physical uplink shared channel transmissions and the SRS configuration information indicates that the first control information is to include the two resource indicators for SRS resources, and wherein an i-th configured SRS resource of a first SRS resource set has a same number of antenna ports as an i-th configured SRS resource of a second SRS resource set.

Aspect 33: The method of any of aspects 20 through 32, wherein the first set of repetitions of the first uplink communication and the second set of repetitions of the first uplink communication are non-codebook-based physical uplink shared channel transmissions and the SRS configuration information indicates that the first control information is to include the two resource indicators for SRS resources, and wherein a first quantity of indicated SRS resources within the first set of SRS resources is a same quantity as a second quantity of indicated SRS resources within the second set of SRS resources.

Aspect 34: The method of any of aspects 20 through 33, wherein the SRS configuration information indicates that the first control information is to include a single resource indicator for SRS resources within the first set of SRS resources and the second set of SRS resources, and the first set of SRS resources and the second set of SRS resources have a same number of SRS resources, or a number of bits in the single resource indicator is determined based at least in part on a maximum number of SRS resources of the first set of SRS resources or the second set of SRS resources.

Aspect 35: The method of any of aspects 20 through 34, wherein the transmitting the first control information further comprises: transmitting a two-bit field within the first control information that indicates that the first uplink communication is to use the first set of SRS resources only, is to use the second set of SRS resources only, or that the UE is to use both the first set of SRS resources and the second set of SRS resources and determine which set of repetitions of the first uplink communication is to use the first set of SRS resources and that the other set of repetitions is to use the second set of SRS resources.

Aspect 36: The method of any of aspects 20 through 35, wherein the transmitting the first control information further comprises: transmitting a single bit within the first control information having a first bit value that indicates that the first uplink communication is to use one of the first set of SRS resources or the second set of SRS resources, or having a second bit value that indicates that the first uplink communication is to use both of the first set of SRS resources and the second set of SRS resources.

Aspect 37: The method of aspect 36, wherein the first bit value provides a predetermined indication that the first uplink communication is to use the first set of SRS resources, the first bit value is configured with the SRS configuration information to indicate that the first uplink communication is to use the first set of SRS resources, or the first bit value indicates that a different information field in the first control information provides an indication that the first uplink communication is to use either the first set of SRS resources or the second set of SRS resources.

Aspect 38: The method of any of aspects 20 through 37, wherein an indication that one of the first set of SRS resources or the second set of SRS resources is unused is provided by a reserved value of a resource indication of the associated set of SRS resources.

Aspect 39: An apparatus for wireless communication at a UE, comprising a processor; memory coupled with the processor; and instructions stored in the memory and executable by the processor to cause the apparatus to perform a method of any of aspects 1 through 19.

Aspect 40: An apparatus for wireless communication at a UE, comprising at least one means for performing a method of any of aspects 1 through 19.

Aspect 41: A non-transitory computer-readable medium storing code for wireless communication at a UE, the code comprising instructions executable by a processor to perform a method of any of aspects 1 through 19.

Aspect 42: An apparatus for wireless communication at a base station, comprising a processor; memory coupled with the processor; and instructions stored in the memory and executable by the processor to cause the apparatus to perform a method of any of aspects 20 through 38.

Aspect 43: An apparatus for wireless communication at a base station, comprising at least one means for performing a method of any of aspects 20 through 38.

Aspect 44: A non-transitory computer-readable medium storing code for wireless communication at a base station, the code comprising instructions executable by a processor to perform a method of any of aspects 20 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, sounding reference signal configuration information that indicates whether control information that provides an uplink grant to the UE is to include one resource indicator for sounding reference signal resources or two resource indicators for sounding reference signal resources;
receiving first control information that schedules two or more repetitions of a first uplink communication and that indicates an association between the two or more repetitions of the first uplink communication with either a first set of sounding reference signal resources, a second set of sounding reference signal resources, or both;
determining a first set of uplink transmission parameters for a first set of repetitions of the first uplink communication and a second set of uplink transmission parameters for a second set of repetitions of the first uplink communication based at least in part on one or two resource indicators in the first control information and the indicated one or both of the first set of sounding reference signal resources or the second set of sounding reference signal resources associated with the two or more repetitions of the first uplink communication; and
transmitting the first set of repetitions of the first uplink communication using the first set of uplink transmission parameters and the second set of repetitions of the first uplink communication using the second set of uplink transmission parameters.

2. The method of claim 1, wherein the first set of sounding reference signal resources are associated with the first set of repetitions of the first uplink communication and the second set of sounding reference signal resources are associated with the second set of repetitions of the first uplink communication, and wherein the first set of repetitions of the first uplink communication is transmitted to a first transmission-reception point and the second set of repetitions of the first uplink communication is transmitted to a second transmission-reception point.

3. The method of claim 1, wherein the first set of repetitions of the first uplink communication and the second set of repetitions of the first uplink communication are codebook-based or non-codebook-based physical uplink shared channel transmissions.

4. The method of claim 1, wherein the receiving the first control information further comprises:
decoding a first resource indictor in the first control information that provides a first sounding reference signal resource of the first set of sounding reference signal resources; and
decoding a second resource indicator in the first control information that provides a second sounding reference signal resource of the second set of sounding reference signal resources.

5. The method of claim 1, wherein the sounding reference signal configuration information indicates that the first control information is to include the two resource indicators for sounding reference signal resources, and wherein the method further comprises:
identifying that the first control information indicates that a single sounding reference signal resource set is associated with the first uplink communication;
determining both the first set of uplink transmission parameters and the second set of uplink transmission parameters based at least in part on a first resource indicator in the first control information; and
ignoring a second resource indicator in the first control information.

6. The method of claim 1, wherein the sounding reference signal configuration information indicates that the first control information is to include the two resource indicators for sounding reference signal resources, and wherein the method further comprises:
identifying that the first control information indicates that two sounding reference signal resource sets are associated with the first uplink communication;
determining the first set of uplink transmission parameters based at least in part on a first resource indicator of the two resource indicators in the first control information; and
determining the second set of uplink transmission parameters based at least in part on a second resource indicator of the two resource indicators in the first control information.

7. The method of claim 1, wherein the sounding reference signal configuration information indicates that the first control information is to include a single resource indicator for sounding reference signal resources, and wherein both the first set of uplink transmission parameters and the second set of uplink transmission parameters are determined based at least in part on the single resource indicator in the first control information.

8. The method of claim 7, further comprising:
identifying that the first control information indicates that a single sounding reference signal resource set is associated with the first uplink communication; and
determining both the first set of uplink transmission parameters and the second set of uplink transmission parameters based at least in part on the single resource indicator in the first control information and the single sounding reference signal resource set.

9. The method of claim 7, further comprising:
identifying that the first control information indicates that two sounding reference signal resource sets are associated with the first uplink communication;
determining the first set of uplink transmission parameters based at least in part on the single resource indicator in the first control information and a first mapping between the single resource indicator and sounding reference signal resources of a first sounding reference signal resource set; and
determining the second set of uplink transmission parameters based at least in part on the single resource indicator in the first control information and a second mapping between the single resource indicator and sounding reference signal resources of a second sounding reference signal resource set.

10. The method of claim 1, wherein the first set of repetitions of the first uplink communication and the second set of repetitions of the first uplink communication are codebook-based physical uplink shared channel transmissions and the sounding reference signal configuration information indicates that the first control information is to include the two resource indicators for sounding reference signal resources, and wherein each of the two resource indicators are mapped to sounding reference signal resources within the associated set of sounding reference signal resources that have a same number of antenna ports.

11. The method of claim 1, wherein the first set of repetitions of the first uplink communication and the second set of repetitions of the first uplink communication are non-codebook-based physical uplink shared channel transmissions and the sounding reference signal configuration information indicates that the first control information is to include the two resource indicators for sounding reference signal resources, and wherein a first quantity of indicated sounding reference signal resources within the first set of sounding reference signal resources is a same quantity as a second quantity of indicated sounding reference signal resources within the second set of sounding reference signal resources.

12. The method of claim 1, wherein:
the sounding reference signal configuration information indicates that the first control information is to include a single resource indicator for sounding reference signal resources within the first set of sounding reference signal resources and the second set of sounding reference signal resources, and
the first set of sounding reference signal resources and the second set of sounding reference signal resources have a same number of sounding reference signal resources, or a number of bits in the single resource indicator is determined based at least in part on a maximum number of sounding reference signal resources of the first set of sounding reference signal resources or the second set of sounding reference signal resources.

13. The method of claim 1, wherein the receiving the first control information further comprises:
identifying a two-bit field within the first control information that indicates that the first uplink communication is to use the first set of sounding reference signal resources only, is to use the second set of sounding reference signal resources only, or is to use both the first set of sounding reference signal resources and the second set of sounding reference signal resources and determine which set of repetitions of the first uplink communication is to use the first set of sounding reference signal resources and that the other set of repetitions is to use the second set of sounding reference signal resources.

14. The method of claim 1, wherein the sounding reference signal configuration information separately configures two or more different control information formats to include the one resource indicator for sounding reference signal resources or the two resource indicators for sounding reference signal resources.

15. The method of claim 1, wherein:
the first set of repetitions of the first uplink communication and the second set of repetitions of the first uplink communication are codebook-based physical uplink shared channel transmissions and one sounding reference signal resource within each set of sounding reference signal resources is indicated for each codebook-based resource indicator, or
the first set of repetitions of the first uplink communication and the second set of repetitions of the first uplink communication are non-codebook-based physical uplink shared channel transmissions and one or more sounding reference signal resources within each set of sounding reference signal resources are indicated for each non-codebook-based resource indicator.

16. The method of claim 1, wherein the first set of repetitions of the first uplink communication and the second set of repetitions of the first uplink communication are codebook-based physical uplink shared channel transmissions and the sounding reference signal configuration information indicates that the first control information is to include the two resource indicators for sounding reference signal resources, and wherein an i-th configured sounding reference signal resource of a first sounding reference signal resource set has a same number of antenna ports as an i-th configured sounding reference signal resource of a second sounding reference signal resource set.

17. The method of claim 1, wherein the receiving the first control information further comprises:
identifying a single bit within the first control information having a first bit value that indicates that the first uplink communication is to use one of the first set of sounding reference signal resources or the second set of sounding reference signal resources, or having a second bit value that indicates that the first uplink communication is to use both of the first set of sounding reference signal resources and the second set of sounding reference signal resources.

18. The method of claim 17, wherein:
the first bit value provides a predetermined indication that the first uplink communication is to use the first set of sounding reference signal resources,
the first bit value is configured by the sounding reference signal configuration information to indicate that the first uplink communication is to use the first set of sounding reference signal resources, or
the first bit value indicates that a different information field in the first control information provides an indication that the first uplink communication is to use either the first set of sounding reference signal resources or the second set of sounding reference signal resources.

19. The method of claim 1, wherein an indication that one of the first set of sounding reference signal resources or the second set of sounding reference signal resources is unused is provided by a reserved value of a resource indication of the associated set of sounding reference signal resources.

20. An apparatus for wireless communication at a user equipment (UE), comprising:
a processor;
memory coupled with the processor; and
instructions stored in the memory and executable by the processor to cause the apparatus to:
receive, from a base station, sounding reference signal configuration information that indicates whether control information that provides an uplink grant to the UE is to include one resource indicator for sounding reference signal resources or two resource indicators for sounding reference signal resources;
receive first control information that schedules two or more repetitions of a first uplink communication and that indicates an association between the two or more repetitions of the first uplink communication with either a first set of sounding reference signal resources, a second set of sounding reference signal resources, or both;
determine a first set of uplink transmission parameters for a first set of repetitions of the first uplink communication and a second set of uplink transmission parameters for a second set of repetitions of the first uplink communication based at least in part on one or two resource indicators in the first control information and the indicated one or both of the first set of sounding reference signal resources or the second set of sounding reference signal resources associated with the two or more repetitions of the first uplink communication; and
transmit the first set of repetitions of the first uplink communication using the first set of uplink transmission parameters and the second set of repetitions of the first uplink communication using the second set of uplink transmission parameters.

21. The apparatus of claim 20, wherein the first set of sounding reference signal resources are associated with the first set of repetitions of the first uplink communication and the second set of sounding reference signal resources are associated with the second set of repetitions of the first uplink communication, and wherein the first set of repetitions of the first uplink communication is transmitted to a first transmission-reception point and the second set of repetitions of the first uplink communication is transmitted to a second transmission-reception point.

22. The apparatus of claim 20, wherein the instructions to receive the first control information are further executable by the processor to cause the apparatus to:
decode a first resource indictor in the first control information that provides a first sounding reference signal resource of the first set of sounding reference signal resources; and
decode a second resource indicator in the first control information that provides a second sounding reference signal resource of the second set of sounding reference signal resources.

23. The apparatus of claim 20, wherein the sounding reference signal configuration information indicates that the first control information is to include the two resource indicators for sounding reference signal resources, and the instructions are further executable by the processor to cause the apparatus to:
identify that the first control information indicates that a single sounding reference signal resource set is associated with the first uplink communication;
determine both the first set of uplink transmission parameters and the second set of uplink transmission parameters based at least in part on a first resource indicator in the first control information; and
ignore a second resource indicator in the first control information.

24. The apparatus of claim 20, wherein the sounding reference signal configuration information indicates that the first control information is to include the two resource indicators for sounding reference signal resources, and the instructions are further executable by the processor to cause the apparatus to:
identify that the first control information indicates that two sounding reference signal resource sets are associated with the first uplink communication;
determine the first set of uplink transmission parameters based at least in part on a first resource indicator of the two resource indicators in the first control information; and
determine the second set of uplink transmission parameters based at least in part on a second resource indicator of the two resource indicators in the first control information.

25. The apparatus of claim 20, wherein the sounding reference signal configuration information indicates that the first control information is to include a single resource indicator for sounding reference signal resources, and wherein both the first set of uplink transmission parameters and the second set of uplink transmission parameters are determined based at least in part on the single resource indicator in the first control information.

26. The apparatus of claim 25, wherein the instructions are further executable by the processor to cause the apparatus to:
identify that the first control information indicates that a single sounding reference signal resource set is associated with the first uplink communication; and
determine both the first set of uplink transmission parameters and the second set of uplink transmission parameters based at least in part on the single resource indicator in the first control information and the single sounding reference signal resource set.

27. The apparatus of claim 25, wherein the instructions are further executable by the processor to cause the apparatus to:
identify that the first control information indicates that two sounding reference signal resource sets are associated with the first uplink communication;
determine the first set of uplink transmission parameters based at least in part on the single resource indicator in the first control information and a first mapping between the single resource indicator and sounding reference signal resources of a first sounding reference signal resource set; and
determine the second set of uplink transmission parameters based at least in part on the single resource indicator in the first control information and a second mapping between the single resource indicator and sounding reference signal resources of a second sounding reference signal resource set.

28. The apparatus of claim 20, wherein the first set of repetitions of the first uplink communication and the second set of repetitions of the first uplink communication are codebook-based physical uplink shared channel transmissions and the sounding reference signal configuration information indicates that the first control information is to include the two resource indicators for sounding reference signal resources, and wherein each of the two resource indicators are mapped to sounding reference signal resources within the associated set of sounding reference signal resources that have a same number of antenna ports.

29. An apparatus for wireless communication at a user equipment (UE), comprising:
means for receiving, from a base station, sounding reference signal configuration information that indicates whether control information that provides an uplink grant to the UE is to include one resource indicator for sounding reference signal resources or two resource indicators for sounding reference signal resources;
means for receiving first control information that schedules two or more repetitions of a first uplink communication and that indicates an association between the two or more repetitions of the first uplink communication with either a first set of sounding reference signal resources, a second set of sounding reference signal resources, or both;
means for determining a first set of uplink transmission parameters for a first set of repetitions of the first uplink communication and a second set of uplink transmission parameters for a second set of repetitions of the first uplink communication based at least in part on one or two resource indicators in the first control information and the indicated one or both of the first set of sounding reference signal resources or the second set of sounding reference signal resources associated with the two or more repetitions of the first uplink communication; and
means for transmitting the first set of repetitions of the first uplink communication using the first set of uplink transmission parameters and the second set of repetitions of the first uplink communication using the second set of uplink transmission parameters.

30. A non-transitory computer-readable medium storing code for wireless communication at a user equipment (UE), the code comprising instructions executable by a processor to:
receive, from a base station, sounding reference signal configuration information that indicates whether control information that provides an uplink grant to the UE is to include one resource indicator for sounding reference signal resources or two resource indicators for sounding reference signal resources;
receive first control information that schedules two or more repetitions of a first uplink communication and that indicates an association between the two or more repetitions of the first uplink communication with either a first set of sounding reference signal resources, a second set of sounding reference signal resources, or both;
determine a first set of uplink transmission parameters for a first set of repetitions of the first uplink communication and a second set of uplink transmission parameters for a second set of repetitions of the first uplink communication based at least in part on one or two resource indicators in the first control information and the indicated one or both of the first set of sounding reference signal resources or the second set of sounding reference signal resources associated with the two or more repetitions of the first uplink communication; and
transmit the first set of repetitions of the first uplink communication using the first set of uplink transmission parameters and the second set of repetitions of the first uplink communication using the second set of uplink transmission parameters.
